(19) United States
(12) Patent Application Publication
(10) Pub. No.: US 2023/0114901 A1
(43) Pub. Date: Apr. 13, 2023

(54) ZOOM LENS AND IMAGE PICKUP APPARATUS HAVING THE SAME

(71) Applicant: CANON KABUSHIKI KAISHA, Tokyo (JP)

(72) Inventor: Shinichiro Saito, Tochigi (JP)

(21) Appl. No.: 17/959,331

(22) Filed: Oct. 4, 2022

(30) Foreign Application Priority Data
Oct. 12, 2021 (JP) 2021-167603

(51) Int. Cl. G02B 9/64; G02B 13/00

(52) U.S. Cl. CPC G02B 9/64; G02B 13/006

(57) ABSTRACT

A zoom lens consists of, from an object side, positive, negative, and positive first to third lens units and a rear unit including one or more lens units. Each distance between adjacent lens units changes during zooming. During zooming from wide-angle to telephoto ends, the first lens unit moves, a distance between the first and second lens units widens, and a distance between the second and third lens units narrows. A positive unit is the third lens unit or is, if an image-side lens unit next to the third lens unit is a positive lens unit, a lens unit of the third and positive lens units. The positive unit includes, from the object side, negative and positive first and second cemented lenses. The first cemented lens consists of, from the object side, a biconvex-shaped positive first lens and a negative second lens. Predetermined conditions are satisfied.

### BACKGROUND OF THE INVENTION

### Field of the Invention

An aspect of embodiments of the present disclosure relates to a zoom lens that is suitable for digital video cameras, digital still cameras, broadcasting cameras, silver-halide film cameras, monitoring cameras, and the like.

### Description of the Related Art

Conventionally, it has been proposed to use, in zoom lenses used in photographing cameras and video cameras, an inner focus method or a rear focus method each of which performs focusing by moving a lens unit on a rear side (image side) of a first lens unit that is located on an object side.

In digital cameras and video cameras, the number of pixels of solid-state image sensors such as CCD and CMOS sensors has been increased. Image pickup lenses have been required to have high optical performance including chromatic aberration reduction, and the sizes thereof have been decreased.

Japanese Patent Laid-Open No. (“JP”) 2014-102525 discloses a zoom lens having a five-unit configuration consisting of lens units having positive, negative, positive, negative, and positive refractive powers in order from an object side. JP 2014-102525 reduces the number of lenses by using an aspherical lens in a fourth lens unit.

JP 2015-018124 discloses a zoom lens having a five-unit configuration consisting of lens units having positive, negative, positive, negative, and negative refractive powers in order from an object side. In JP 2015-018124, a high zoom ratio is provided by optimizing the refractive power of each unit.

In recent years, there has been a strong demand for lens systems used in image pickup apparatuses to have high optical performance while having small entire lens system sizes. When both good optical performance and a small entire lens system size are to be realized, it is important to properly set a refractive power and a configuration of each lens unit, a moving condition of each lens unit during zooming, and the like. In particular, when a lens system of a camera including a large image sensor is to be made small, glass materials having large refractive indexes are often heavily used, and it is required to reduce chromatic aberration while robustness is ensured against decentration of a lens.

An overall lens length can be shortened by using many aspherical lenses and increasing a refractive power of each lens as in JP 2014-102525, but it becomes difficult to reduce on-axis chromatic aberration in an entire zoom range.

In a case where a high zoom ratio and a focal length on a telephoto side are ensured as in JP 2015-018124, it becomes difficult to reduce various aberrations, especially lateral chromatic aberration, on a wide-angle side and to widen an angle of view.

### SUMMARY OF THE INVENTION

The present disclosure provides a wide-angle and small zoom lens that has high optical performance while being robust against manufacturing errors.

A zoom lens according to one aspect of the present disclosure consists of, in order from an object side to an image side, a first lens unit having a positive refractive power, a second lens unit having a negative refractive power, a third lens unit having a positive refractive power, and a rear unit including one or more lens units. Each distance between adjacent lens units changes during zooming. During zooming from a wide-angle end to a telephoto end, the first lens unit moves, a distance between the first lens unit and the second lens unit widens, and a distance between the second lens unit and the third lens unit narrows. In a case where a lens unit on the image side of the third lens unit and immediately next to the third lens unit is not a lens unit having a positive refractive power, a positive unit is the third lens unit, and in a case where the lens unit on the image side of the third lens unit and immediately next to the third lens unit is a lens unit having a positive refractive power, the positive unit is a lens unit consisting of the third lens unit and the lens unit having a positive refractive power. The positive unit includes, in order from the object side to the image side, a first cemented lens having a negative refractive power and a second cemented lens having a positive refractive power. The first cemented lens consists of, in order from the object side to the image side, a first lens having a biconvex shape and having a positive refractive power and a second lens having a negative refractive power. Following inequalities are satisfied:

−1.200<fAN/fGP<−0.795

0.001<|APR2/APR1|<1.150

where fGP represents a focal length of the positive unit at the wide-angle end, fAN represents a focal length of the second lens as a single lens, APR1 represents a curvature radius of an object side of the first lens, and APR2 represents a curvature radius of an image side of the first lens.

A zoom lens according to one aspect of the present disclosure consists of, in order from an object side to an image side, a first lens unit having a positive refractive power, a second lens unit having a negative refractive power, a third lens unit having a positive refractive power, and a rear unit including one or more lens units. Each distance between adjacent lens units changes during zooming. During zooming from a wide-angle end to a telephoto end, the first lens unit moves, a distance between the first lens unit and the second lens unit widens, and a distance between the second lens unit and the third lens unit narrows. In a case where a lens unit on the image side of the third lens unit and immediately next to the third lens unit is not a lens unit having a positive refractive power, a positive unit is the third lens unit, and in a case where the lens unit on the image side of the third lens unit and immediately next to the third lens unit is a lens unit having a positive refractive power, the positive unit is a lens unit consisting of the third lens unit and the lens unit having a positive refractive power. The positive unit includes, in order from the object side to the image side, a first cemented lens having a negative refractive power and a second cemented lens having a positive refractive power. The first cemented lens consists of, in order from the object side to the image side, a first lens having a biconvex shape and having a positive refractive power and a second lens having a negative refractive power. Following inequalities are satisfied:

−1.200<fAN/fGP<−0.795

1.45<ndAN<1.64

where fGP represents a focal length of the positive unit at the wide-angle end, fAN represents a focal length of the second lens, and ndAN represents a refractive index at a d-line of the second lens.

An image pickup apparatus according to another aspect of the present disclosure includes the zoom lens and an image sensor configured to receive light of an image formed by the zoom lens.

Further features of the present invention will become apparent from the following description of exemplary embodiments with reference to the attached drawings.

### BRIEF DESCRIPTION OF THE DRAWINGS

FIG. 1 is lens sectional views at a wide-angle end, a middle zoom position, and a telephoto end of a zoom lens according to Example 1.

FIGS. 2A to 2C are aberration diagrams at the wide-angle end (A), the middle zoom position (B), and the telephoto end (C) of the zoom lens according to Example 1.

FIG. 3 is lens sectional views at a wide-angle end, a middle zoom position, and a telephoto end of a zoom lens according to Example 2.

FIGS. 4A to 4C are aberration diagrams at the wide-angle end (A), the middle zoom position (B), and the telephoto end (C) of the zoom lens according to Example 2.

FIG. 5 is lens sectional views at a wide-angle end, a middle zoom position, and a telephoto end of a zoom lens according to Example 3.

FIGS. 6A to 6C are aberration diagrams at the wide-angle end (A), the middle zoom position (B), and the telephoto end (C) of the zoom lens according to Example 3.

FIG. 7 is lens sectional views at a wide-angle end, a middle zoom position, and a telephoto end of a zoom lens according to Example 4.

FIGS. 8A to 8C are aberration diagrams at the wide-angle end (A), the middle zoom position (B), and the telephoto end (C) of the zoom lens according to Example 4.

FIG. 9 is lens sectional views at a wide-angle end, a middle zoom position, and a telephoto end of a zoom lens according to Example 5.

FIGS. 10A to 10C are aberration diagrams at the wide-angle end (A), the middle zoom position (B), and the telephoto end (C) of the zoom lens according to Example 5.

FIG. 11 is lens sectional views at a wide-angle end, a middle zoom position, and a telephoto end of a zoom lens according to Example 6.

FIGS. 12A to 12C are aberration diagrams at the wide-angle end (A), the middle zoom position (B), and the telephoto end (C) of the zoom lens according to Example 6.

FIG. 13 is a schematic diagram of an image pickup apparatus.

### DESCRIPTION OF THE EMBODIMENTS

Referring now to the accompanying drawings, a description is given of a zoom lens and an image pickup apparatus having the same according to embodiments of the present disclosure.

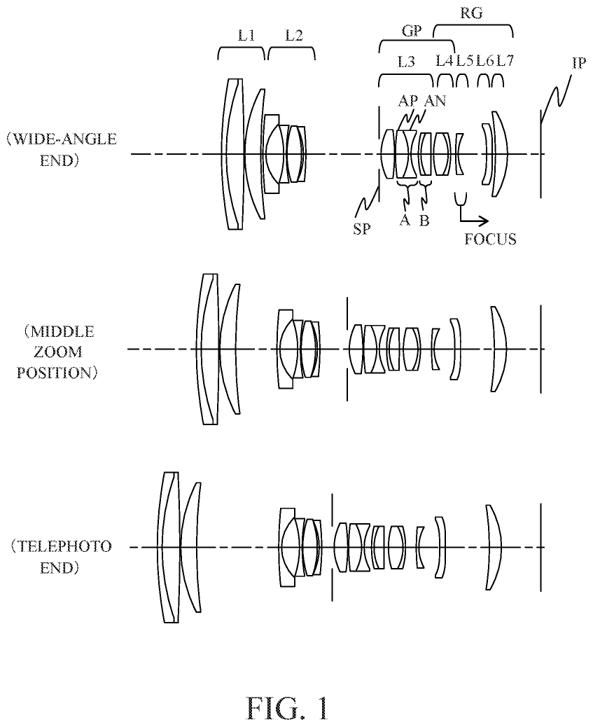

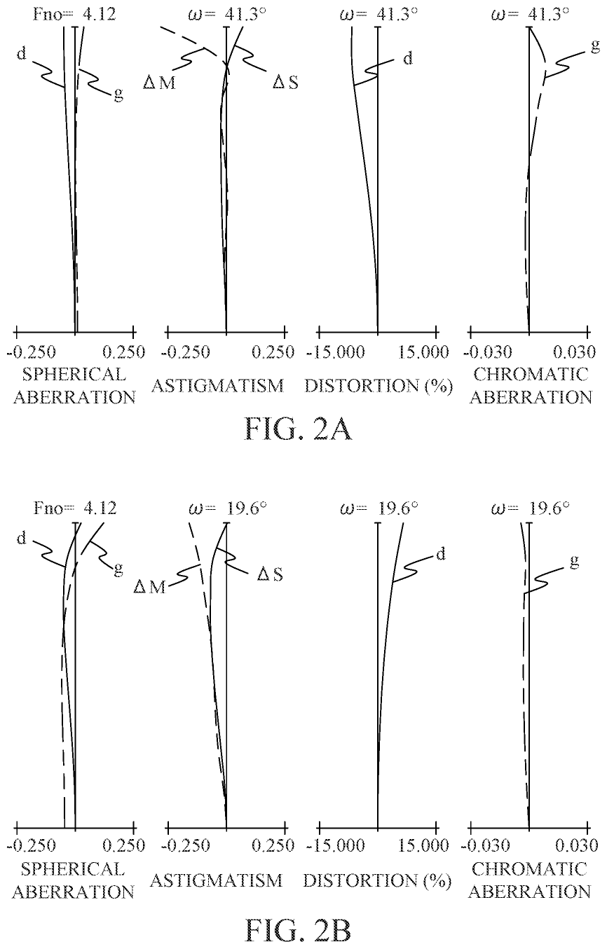

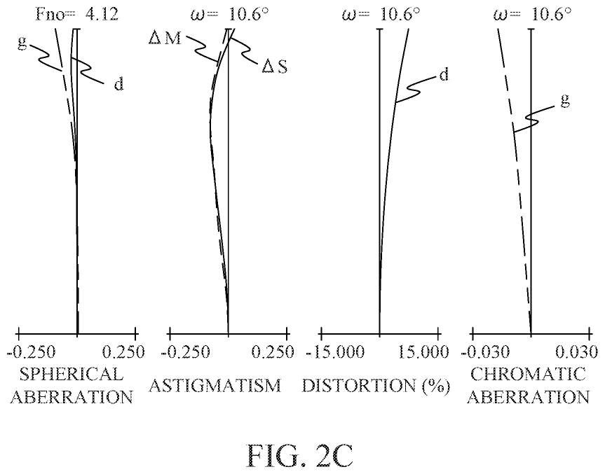

FIG. 1 is lens sectional views at a wide-angle end (short focal length end), a middle zoom position, and a telephoto end (long focal length end) of a zoom lens according to Example 1. FIGS. 2A, 2B, and 2C are aberration diagrams at the wide-angle end, the middle zoom position, and the telephoto end of the zoom lens according to Example 1, respectively. Each aberration diagram according to each example is an aberration diagram in a state where the zoom lens focuses on an object at an infinite distance. The zoom lens according to Example 1 has a zoom ratio of about 4.4 and an aperture ratio of about 4.1.

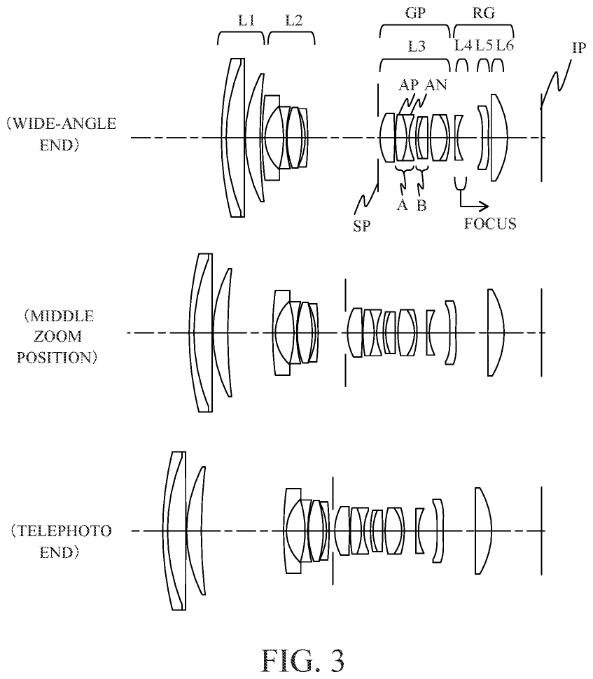

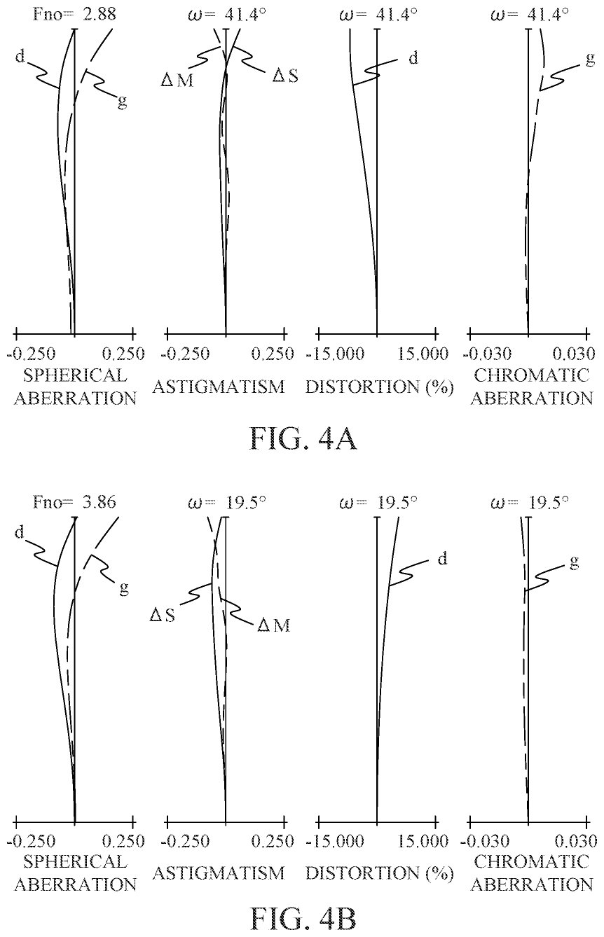

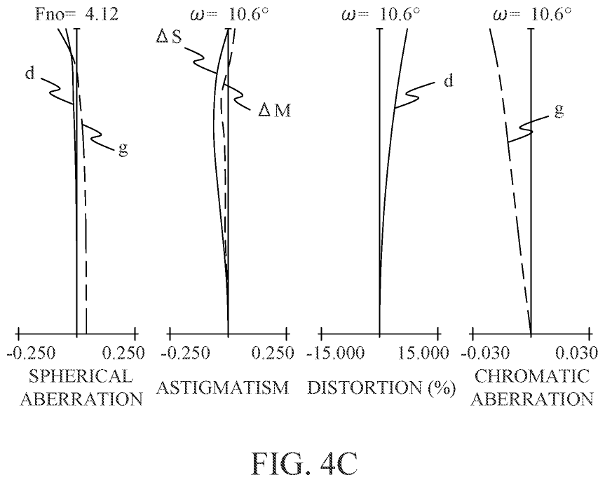

FIG. 3 are lens sectional views at a wide-angle end, a middle zoom position, and a telephoto end of a zoom lens according to Example 2. FIGS. 4A, 4B, and 4C are aberration diagrams at the wide-angle end, the middle zoom position, and the telephoto end of the zoom lens according to Example 2, respectively. The zoom lens according to Example 2 has a zoom ratio of about 4.4 and an aperture ratio of about 2.9-4.1.

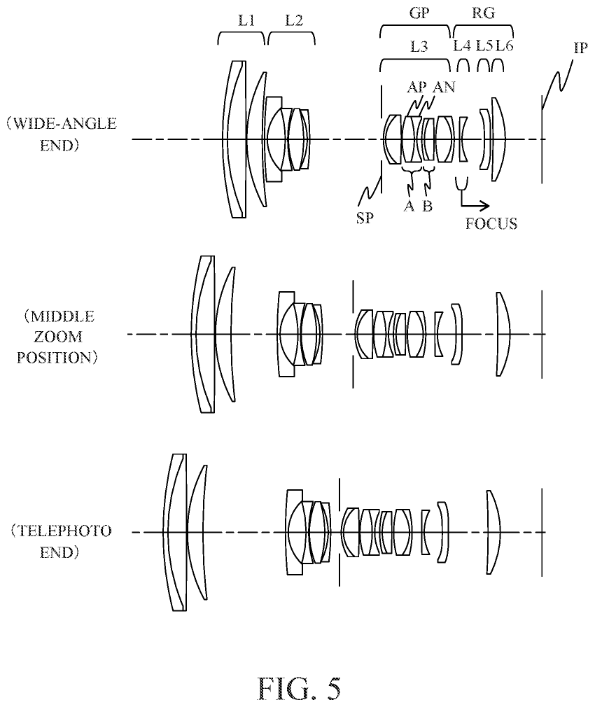

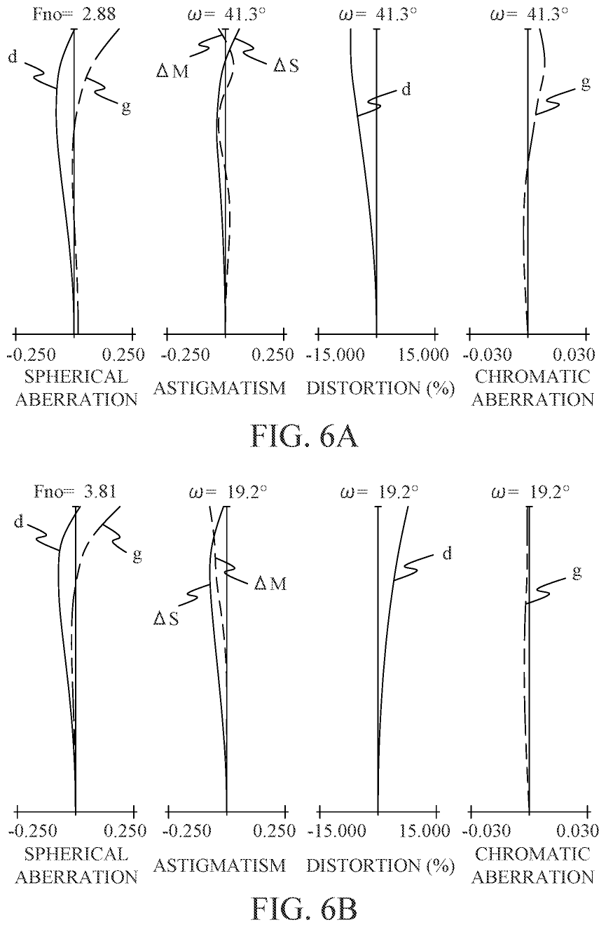

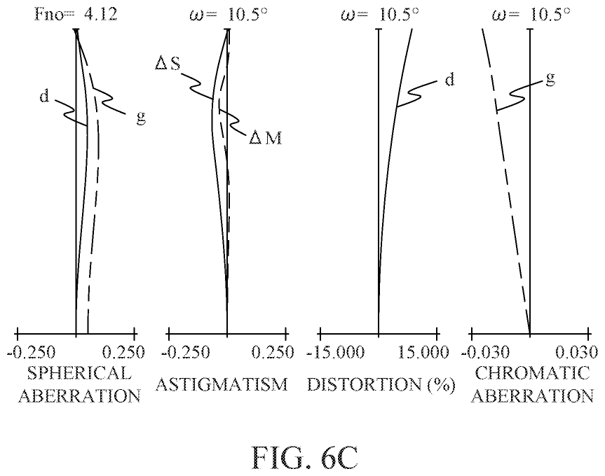

FIG. 5 are lens sectional views at a wide-angle end, a middle zoom position, and a telephoto end of a zoom lens according to Example 3. FIGS. 6A, 6B, and 6C are aberration diagrams at the wide-angle end, the middle zoom position, and the telephoto end of the zoom lens according to Example 3, respectively. The zoom lens according to Example 3 has a zoom ratio of about 4.4 and an aperture ratio of about 2.9-4.1.

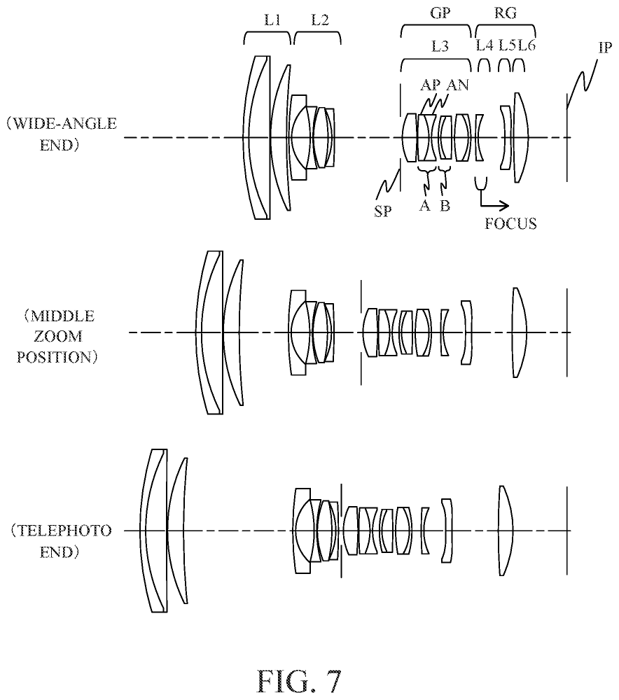

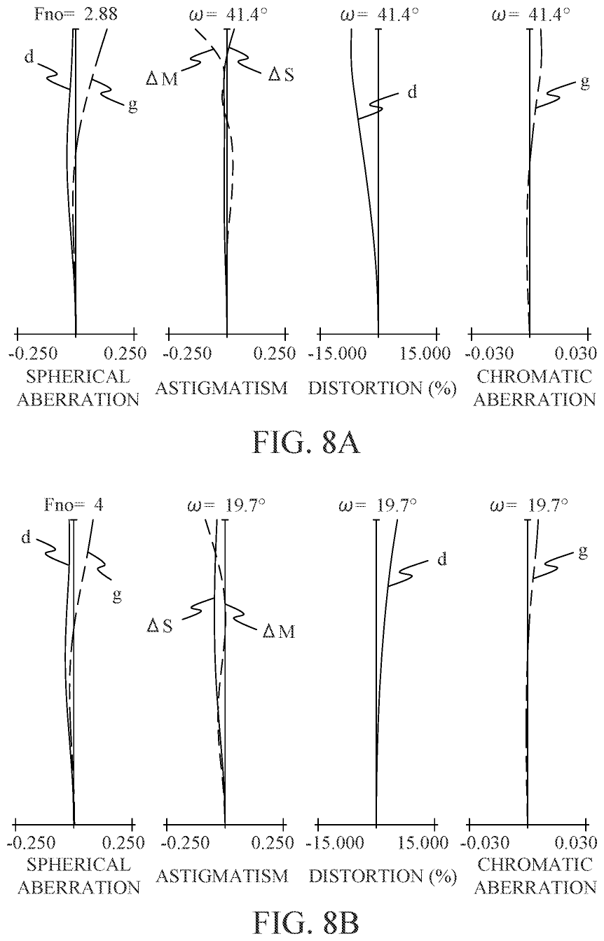

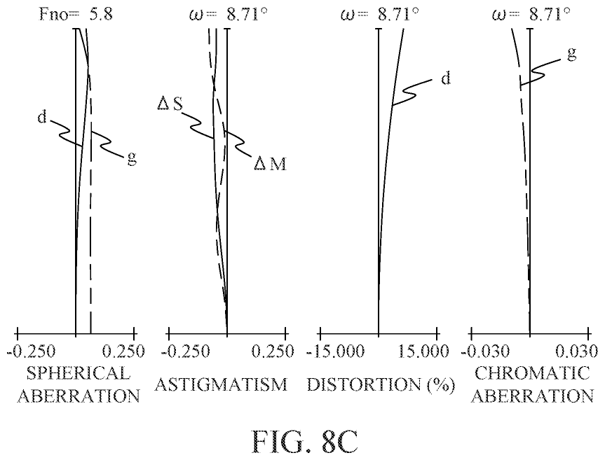

FIG. 7 are lens sectional views at a wide-angle end, a middle zoom position, and a telephoto end of a zoom lens according to Example 4. FIGS. 8A, 8B, and 8C are aberration diagrams at the wide-angle end, the middle zoom position, and the telephoto end of the zoom lens according to Example 4, respectively. The zoom lens according to Example 4 has a zoom ratio of about 5.4 and an aperture ratio of about 2.9-5.8.

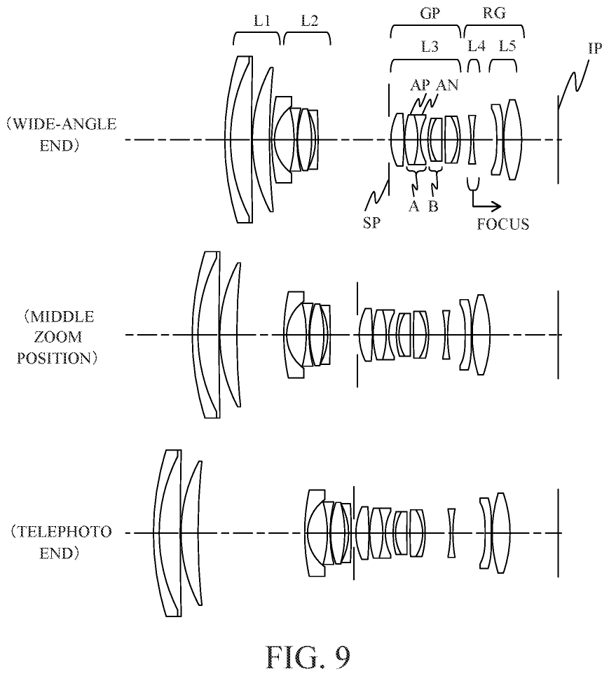

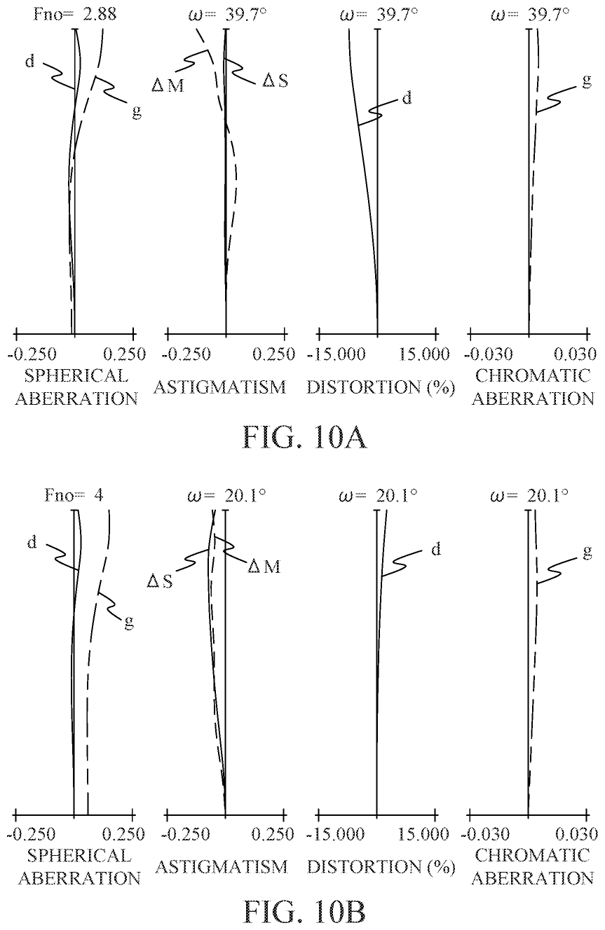

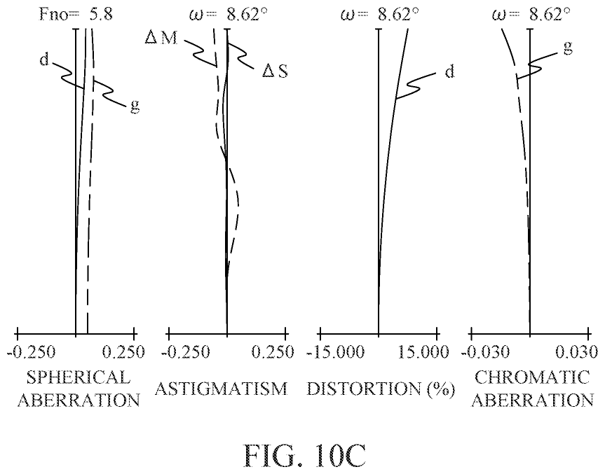

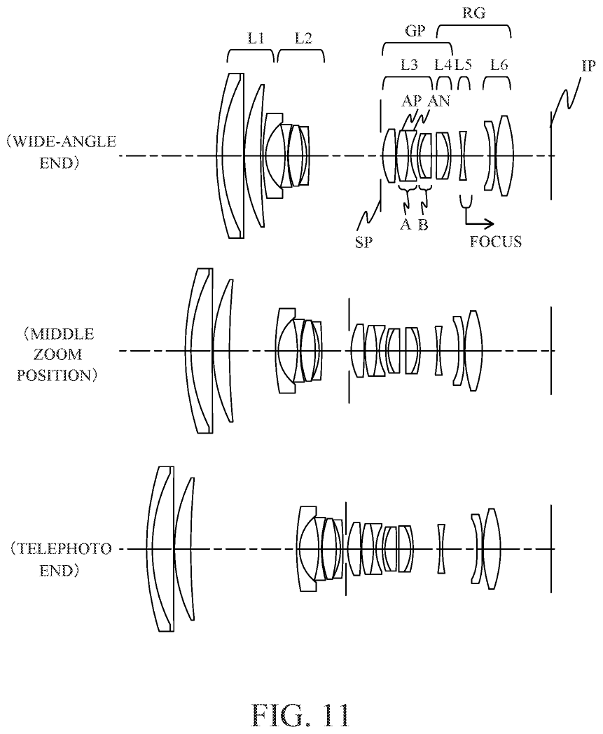

FIG. 9 are lens sectional views at a wide-angle end, a middle zoom position, and a telephoto end of a zoom lens according to Example 5. FIGS. 10A, 10B, and 10C are aberration diagrams at the wide-angle end, the middle zoom position, and the telephoto end of the zoom lens according to Example 5, respectively. The zoom lens according to Example 5 has a zoom ratio of about 5.1 and an aperture ratio of about 2.9-5.8.

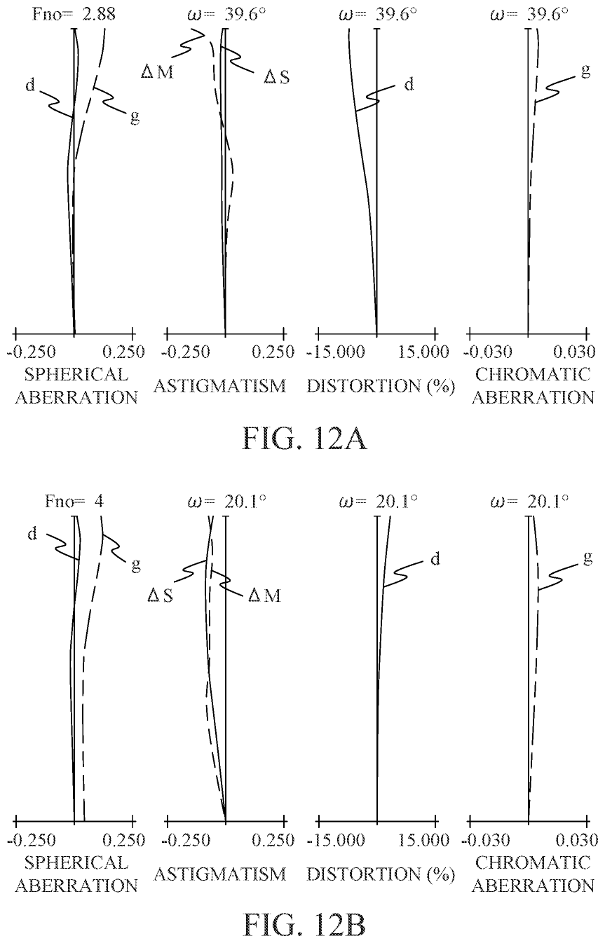

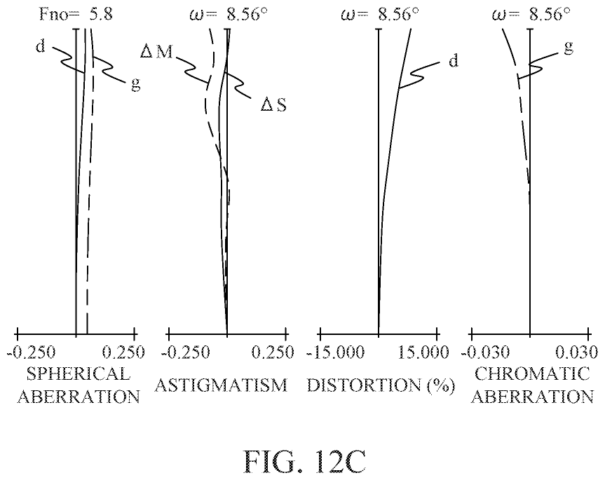

FIG. 11 are lens sectional views at a wide-angle end, a middle zoom position, and a telephoto end of a zoom lens according to Example 6. FIGS. 12A, 12B, and 12C are aberration diagrams at the wide-angle end, the middle zoom position, and the telephoto end of the zoom lens according to Example 6, respectively. The zoom lens according to Example 6 has a zoom ratio of about 5.1 and an aperture ratio of about 2.9-5.8.

The zoom lens according to each example is an image pickup optical system used in an image pickup apparatus such as a digital video camera, a digital still camera, a broadcasting camera, a silver-halide film camera, and a monitoring camera. The zoom lens according to each example may also be used as a projection optical system for a projecting apparatus (projector).

In each lens sectional view, a left side is an object side (front side) and a right side is an image side (rear side). The zoom lens according to each example includes a plurality of lens units. In the specification of the present application, a lens unit refers to a group of lenses that move or stop as a whole during zooming. That is, in the zoom lens according to each example, each distance between adjacent lens units changes during zooming from the wide-angle end to the telephoto end. A lens unit may consist of a single lens, and may include a plurality of lenses. Further, a lens unit may include an aperture diaphragm.

In each lens sectional view, a reference sign Li denotes an i-th unit, where i represents an order of a lens unit counted from the object side. A reference sign SP denotes an aperture diaphragm that determines (limits) a light beam at an open F number (Fno). A reference sign IP denotes an image plane, and in a case where the zoom lens according to each example is used as an image pickup optical system for a digital still camera or a digital video camera, an image pickup plane of a solid image sensor (photoelectric conversion element) such as a CCD sensor and a CMOS sensor is disposed on the image plane IP. In a case where the zoom lens according to each example is used as an image pickup optical system of a silver-halide film camera, a photosensitive surface corresponding to a film surface is disposed on the image plane IP. Arrows relating to focus indicate moving directions of lens units during focusing from an object at an infinite distance to an object at a close distance.

In each spherical aberration diagram, Fno represents an F-number, and each spherical aberration diagram illustrates spherical aberration amounts at a d-line (wavelength 587.56 nm) and a g-line (wavelength 435.835 nm). In each astigmatism diagram, ΔS represents an astigmatism amount on a sagittal image plane, and ΔM represents an astigmatism amount on a meridional image plane. Each distortion diagram illustrates an amount of distortion at the d-line. Each chromatic aberration diagram illustrates a chromatic aberration amount at the g-line. ω represents an image pickup half angle of view (°) and the angle of view is based on a ray tracking value. In each example described below, a wide-angle end and a telephoto end refer to zoom positions in states where a lens unit for magnification variation (zooming) is located at both ends of a mechanically movable range on an optical axis.

Next, a description is given of a characteristic configuration in the zoom lens according to each example.

The zoom lens according to each example includes, in order from the object side to the image side, a first lens unit L1 having a positive refractive power (optical power=reciprocal of focal length), a second lens unit L2 having a negative refractive power, a third lens unit L3 having a positive refractive power, and a rear unit RG including one or more lens units. That is, the zoom lens includes four or more lens units. Each distance between adjacent lens units changes during zooming. During zooming from a wide-angle end to a telephoto end, the first lens unit L1 moves, a distance between the first lens unit L1 and the second lens unit L2 widens, and a distance between the second lens unit L2 and the third lens unit L3 narrows. In a case where a lens unit on the image side of the third lens unit L3 and immediately next to the third lens unit L3 is not a lens unit having a positive refractive power, the third lens unit L3 is also referred to as a lens unit GP (positive unit), and in a case where the lens unit on the image side of the third lens unit L3 and immediately next to the third lens unit L3 is a lens unit having a positive refractive power, a lens unit consisting of the third lens unit L3 and the lens unit having the positive refractive power is referred to as the lens unit GP (positive unit). The lens unit GP includes, in order from the object side to the image side, a cemented lens A (first cemented lens) having a negative refractive power, and a cemented lens B (second cemented lens) having a positive refractive power. The cemented lens A includes, in order from the object side to the image side, a biconvex-shaped lens AP (first lens) having a positive refractive power and a lens AN (second lens) having a negative refractive power.

The zoom lens according to each example satisfies the following inequalities (1) and (2).

−1.200<fAN/fGP<−0.795 (1)

0.001<|APR2/APR1|<1.150 (2)

Here, fGP represents a focal length of the lens unit GP at the wide-angle end, and fAN represents a focal length of the negative lens AN as a single lens. APR1 and APR2 respectively represent curvature radii of the object side and image side of the positive lens AP.

The zoom lens according to each example includes, in order from the object side to the image side, the first to third lens units having the positive, negative, and positive refractive powers so that an overall lens length is shorten at the wide-angle end and aberration is corrected well over an entire zoom range. Since the zoom lens according to each example includes at least four lens units, spherical aberration and coma occurring in the first lens unit L1 and the second lens unit L2 are effectively corrected. In a range on the telephoto side, variations in spherical aberration and coma caused by manufacturing errors are large. Therefore, a zoom type of the zoom lens according to each example is a so-called positive lead type in which the first lens unit L1 has the positive refractive power so that a height is reduced of an on-axis ray entering each lens element on the image side of the second lens unit L2, which leads to size reduction and improved robustness.

Furthermore, in order that the size is reduced and a high magnification variation ratio (zoom ratio) is ensured, zooming is performed by changing each distance between adjacent lens units so that, at the telephoto end, the distance between the first lens unit L1 and the second lens unit L2 is wide and the distance between the second lens unit L2 and the third lens unit L3 is narrow, as compared with those at the wide-angle end.

The lens unit GP consists of the third lens unit L3, or includes, in a case where the lens unit on the image side of the third lens unit L3 and immediately next to the third lens unit L3 is a lens unit having a positive refractive power, the third lens unit L3 and the lens unit having the positive refractive power. The lens unit GP includes, in order from the object side to the image side, the cemented lens A having the negative refractive power, and the cemented lens B having the positive refractive power. The lens unit GP that performs magnification variation has a positive refractive power as a whole and incudes a plurality of lenses. For a purpose of reducing variations in spherical aberration and coma caused by zooming while the size is reduced, each distance between part of adjacent lens units having positive refractive powers may be changed.

The cemented lens A includes, in order from the object side to the image side, the positive lens AP having a biconvex shape and the negative lens AN. The cemented lens A makes it easy to reduce variations in spherical aberration and coma at different wavelengths, the variations being a problem when a lens diameter is increased. Further, in a case where the refractive power of the positive lens AP is increased, the curvature radius decreases. This raises a problem of a variation in coma due to decentration caused by a manufacturing error, but the cemented lens A ensures robustness against the variation and makes it easy to ensure good optical performance.

In a case where a refractive index of the negative lens AN is higher than a refractive index of the positive lens AP, cemented surfaces cause light to diverge, which is disadvantageous to correction of chromatic aberration but makes it easy to correct spherical aberration. In the opposite case, the cemented surfaces cause light to converge, which is beneficial to chromatic aberration correction but makes it difficult to correct spherical aberration. Therefore, the cemented lens B is located on the image side of the cemented lens A so that the configuration is such that two cemented lenses are disposed, which makes it possible to compensate for insufficient correction of various aberrations caused by the selection of glass materials and to correct various aberrations without many aspherical lenses used.

The inequality (1) specifies the focal length of the negative lens AN relative to the focal length of the lens unit GP at the wide-angle end and is for ensuring a share of magnification variation of the lens unit GP and correcting spherical aberration and coma. If the refractive power of the negative lens AN is so strong relatively to the refractive power of the lens unit GP that the value is larger than the upper limit of the inequality (1), it is difficult to ensure the share of magnification variation, which causes increase in the overall lens length at the telephoto end. If the refractive power of the negative lens AN is so weak that the value is smaller than the lower limit of the inequality (1), an on-axis light beam entering the cemented lens B becomes strongly converging light, which makes it difficult to reduce coma in a wide-angle range.

The inequality (2) specifies a ratio between the curvature radius of the object side of the positive lens AP and the curvature radius of the image side of the positive lens AP, and optimizes a correction effect on chromatic aberration while ensuring the refractive power of the positive lens AP. If the curvature radius of the object side of the positive lens AP is so small that the value is larger than the upper limit of the inequality (2), it is beneficial to the spherical aberration correction, but it becomes difficult to reduce the variation in coma at different wavelengths. If the curvature radius of the object side of the positive lens AP is so large that the value is smaller than the lower limit of the inequality (2), the curvature radii of the cemented surfaces are too small, which causes a variation in spherical aberration during zooming.

The numerical ranges of the inequalities (1) and (2) may be set to numerical ranges of the following inequalities (1a) and (2a).

−1.100<fAN/fGP<−0.800 (1a)

0.100<|APR2/APR1|<1.100 (2a)

If the inequality (1a) is satisfied, it is easy to reduce coma while on-axis chromatic aberration in the wide-angle range is reduced. If the inequality (2a) is satisfied, it may be possible to reduce the overall lens length while the spherical aberration on the telephoto side is reduced.

The numerical ranges of the inequalities (1) and (2) may be set to numerical ranges of the following inequalities (1b) and (2b).

−1.050<fAN/fGP<−0.802 (1b)

0.150<|APR2/APR1|<1.095 (2b)

As described above, by properly configuring each lens unit so that both the inequalities (1) and (2) are satisfied, it is possible to realize a wide-angle and small zoom lens that corrects well aberrations such as chromatic aberration and spherical aberration and is robust against manufacturing errors.

The zoom lens according to another aspect of each example may be configured as described below.

The zoom lens according to the other aspect of each example includes, in order from an object side to an image side, a first lens unit L1 having a positive refractive power, a second lens unit L2 having a negative refractive power, a third lens unit L3 having a positive refractive power, and a rear unit RG including one or more lens units. That is, the zoom lens includes four or more lens units. Each distance between adjacent lens units changes during zooming. During zooming from a wide-angle end to a telephoto end, the first lens unit L1 moves, a distance between the first lens unit L1 and the second lens unit L2 widens, and a distance between the second lens unit L2 and the third lens unit L3 narrows. In a case where a lens unit on the image side of the third lens unit L3 and immediately next to the third lens unit L3 is not a lens unit having a positive refractive power, the third lens unit L3 is also referred to as a lens unit GP (positive unit), and in a case where the lens unit on the image side of the third lens unit L3 and immediately next to the third lens unit L3 is a lens unit having a positive refractive power, a lens unit consisting of the third lens unit L3 and the lens unit having the positive refractive power is referred to as the lens unit GP (positive unit). The lens unit GP includes, in order from the object side to the image side, a cemented lens A (first cemented lens) having a negative refractive power, and a cemented lens B (second cemented lens) having a positive refractive power. The cemented lens A includes, in order from the object side to the image side, a biconvex-shaped lens AP (first lens) having a positive refractive power and a lens AN (second lens) having a negative refractive power.

The zoom lens according to the other aspect of each example satisfies the following inequalities (1) and (3).

−1.200<fAN/fGP<−0.795 (1)

1.45<ndAN<1.64 (3)

Here, fGP represents a focal length of the lens unit GP at the wide-angle end, and fAN represents a focal length of the negative lens AN. ndAN represents a refractive index at the d-line of the negative lens AN (optical element).

A description is omitted of part of configurations and conditions of the zoom lens same as or similar to the configurations and the conditions of the zoom lens described above.

The inequality (3) specifies the refractive index at the d-line of the negative lens AN. In a case where the refractive index of the negative lens AN is increased, it is easy to correct spherical aberration, but the cemented surfaces cause light to diverge, which is disadvantageous to correction of chromatic aberration. Especially in the wide-angle range, in order that the cemented lens A is made to correct both chromatic aberration and spherical aberration, it is important to properly set the refractive index of the negative lens AN. If the refractive index is larger than the upper limit of the inequality (3), the curvature radii of the cemented surfaces of cemented lens A become so large that it is difficult to correct both first-order chromatic aberration and coma. If the refractive index is smaller than the lower limit of the inequality (3), it becomes difficult to reduce high-order spherical aberration.

The numerical ranges of the inequalities (1) and (3) may be set to numerical ranges of the following inequalities (1a) and (3a).

−1.100<fAN/fGP<−0.800 (1a)

1.47<ndAN<1.60 (3a)

If the inequality (1a) is satisfied, it is easy to reduce coma while on-axis chromatic aberration in the wide-angle range is reduced. If the inequality (3a) is satisfied, it is easy to reduce spherical aberration and coma in the entire zoom range.

The numerical ranges of the inequalities (1) and (3) may be set to numerical ranges of the following inequalities (1b) and (3b).

−1.050<fAN/fGP<−0.802 (1b)

1.51<ndAN<1.58 (3b)

As described above, by properly configuring each lens unit so that both the inequalities (1) and (3) are satisfied, it is possible to realize a wide-angle and small zoom lens that corrects well aberrations such as chromatic aberration and spherical aberration and is robust against manufacturing errors.

A description is given of conditions that may be satisfied by the zoom lens according to each example. The zoom lens according to each example may satisfy one or more of the following inequalities (4) and (13).

−0.10<SFA<1.20 (4)

0.7<|APR2/fGP|<1.8 (5)

70.5<νdAP<100.0 (6)

0.60<νdAN/νdAP<0.85 (7)

−2.00<fA/fB<−0.50 (8)

4.2<|f1/f2<|7.0 (9)

3.8<f1/fw<5.5 (10)

1.0<|f3/f2|<2.8 (11)

0.16<f3/ft<0.50 (12)

56<νd3P<80 (13)

Here, SFA represents a shape factor of the cemented lens A. νdAP represents an Abbe number of the positive lens AP. νdAN represents an Abbe number of the negative lens AN. fA represents a focal length of the cemented lens A. fB represents a focal length of the cemented lens B. f1, f2, and f3 represent focal lengths of the first lens unit L1, the second lens unit L2, and the third lens unit L3, respectively. fw and ft represent focal lengths of the zoom lens at the wide-angle end and the telephoto end, respectively. νd3P represents an average Abbe number of a positive lens(es) in the third lens unit L3.

An Abbe number νd and a partial dispersion ratio θgF are defined by the following equations where Nd, NF, NC, and Ng represent refractive indexes at the d-line, an F-line, a C-line, and the g-line of Fraunhofer lines.

νd=(Nd−1)/(NF−NC)

θgF=(Ng−NF)/(NF−NC)

A shape factor SFA is defined by the following equation where APR1 represents a curvature radius of an object side lens surface of the cemented lens A, and ANR2 represents a curvature radius of an image side lens surface of the cemented lens A. In a case where a lens surface has an aspherical shape, the shape factor refers to its base R (a radius of a quadratic surface serving as a reference).

SFA=−(ANR2+APR1)/(ANR2−APR1)

The inequality (4) specifies a shape factor of the cemented lens A, and is for reducing the size while correcting both spherical aberration and on-axis chromatic aberration. In a case where the value of the inequality (4) is 1, the cemented lens A has a planar concave shape in which a concave surface faces the image side. If the value is larger than the upper limit of the inequality (4), it is difficult to correct well coma on the wide-angle side and a variation is large in spherical aberration during zooming. If the value is smaller than the lower limit of the inequality (4), spherical aberration and on-axis chromatic aberration are large on the telephoto side.

The inequality (5) specifies the curvature radii of the cemented surfaces of the cemented lens A relative to the focal length of the lens unit GP at the wide-angle end. For a purpose of the size reduction of the zoom lens, it is effective to increase a share of magnification variation of the lens unit GP, but the size reduction and achromatic performance are to be balanced. The inequality (5) is for properly setting correction of on-axis chromatic aberration and the share of magnification variation. If the value is larger than the upper limit of the inequality (5), the curvature radii of the cemented surfaces become too large for the share of magnification variation, which may cause insufficient correction of the on-axis chromatic aberration on the telephoto side. If the value is smaller than the lower limit of the inequality (5), the refractive power of the lens unit GP is so weak that, if a predetermined magnification variation ratio is to be ensured, the moving amount of the lens unit GP from wide-angle end to telephoto end may be increased, which may lead to an increase in the size of the zoom lens.

The inequality (6) specifies the Abbe number of the material of the positive lens AP and is for reducing on-axis chromatic aberration and making the lens unit GP correct residual of insufficient correction on chromatic aberration by the first lens unit L1 and the second lens unit L. If the value is larger than the upper limit of the inequality (6), it is beneficial to correction on on-axis chromatic aberration, but it becomes difficult for a glass material to ensure a desired refractive power. If the value is smaller than the lower limit of the inequality (6), first-order achromatization on on-axis chromatic aberration and lateral chromatic aberration becomes difficult.

The inequality (7) specifies a ratio between the Abbe number of the positive lens AP and the Abbe number of the negative lens AN in the cemented lens A. and is for performing both correction on on-axis chromatic aberration and correction on spherical aberration and coma. If the value is larger than the upper limit of the inequality (7), the Abbe number of the positive lens AP and the Abbe number of the negative lens AN are close to each other, an achromatic effect of properties of glass materials weakens, and a lens other than the cemented lens A is made to perform achromatization, which may lead to an increase in the number of lenses or an increase in the overall lens length. If the value is smaller than the lower limit of the inequality (7), the achromatic effect of the properties of the glass material is ensured, but the curvature radii of the cemented surfaces are large, and it is difficult to ensure the refractive power of the positive lens AP, which is likely to cause a problem in correction on chromatic aberration.

The inequality (8) specifies a ratio between the focal length fA of the cemented lens A and the focal length fB of the cemented lens B and is for performing both correction on on-axis chromatic aberration and correction on spherical aberration and coma. Satisfying the inequality (8) realizes proper setting of shares of aberration correction of the two cemented lenses A and B and makes it easy to ensure robustness against decentration that is a problem when the lens diameter is increased and/or when the zoom ratio is increased. If the value is larger than the upper limit of the inequality (8), the refractive power of the cemented lens A is too strong, a light beam entering the cemented lens B is likely to become diverging light, and coma is likely to be increased by the decentration of the cemented lens B. If the value is smaller than the lower limit of the inequality (8), the refractive power of cemented lens A is too weak, and spherical aberration is likely to be insufficiently corrected especially on the telephoto side.

The inequality (9) specifies the focal length of the first lens unit L1 relative to the focal length of the second lens unit L2, and is for maintaining a proper magnification variation ratio and reducing the size of the zoom lens. In a zoom lens that is relatively bright on a telephoto side, if the refractive power of the first lens unit L1 is not properly ensured within a range such that aberration can be corrected, the total length increases of the zoom lens on the telephoto side. This may lead to an increase in a diameter of a front lens. If the value is larger than the upper limit of the inequality (9), aberration variations are large in the first lens unit L1 and the second lens unit L2 during zooming, which makes it difficult to correct especially spherical aberration. If the value is smaller than the lower limit of the inequality (9), the refractive power of the first lens unit L1 is small, the total length of the zoom lens increases, and it is difficult to ensure a peripheral light amount.

The inequality (10) specifies the focal length of the first lens unit L1 relative to the focal length of the zoom lens at the wide-angle end, and is for properly setting shares of magnification variation while reducing the size. Setting a desired refractive power for the first lens unit L1 can reduce a moving amount of the first lens unit L1 during zooming. If the value is larger than the upper limit of the inequality (10), the refractive power of the first lens unit L1 is weak, which weakens a magnification variation effect. If the magnification variation effect is increased by increasing the moving amount of the first lens unit L1 during zooming, the overall length increases at the telephoto end. Further, if the value is larger than the upper limit of the inequality (10), a lens unit(s) on the image side of the third lens unit L3 is made to take a share of magnification variation, which increases occurrences of aberrations such as spherical aberration and coma on the telephoto side. As a result, the number of lenses and the number of aspherical lenses are increased for aberration correction, and robustness against manufacturing errors is likely to be lost. If the value is smaller than the lower limit of the inequality (10), the refractive power of the first lens unit L1 is too strong, and spherical aberration occurring in the first lens unit L1 increases on the telephoto side.

The inequality (11) specifies the focal length of the third lens unit L3 relative to the focal length of the second lens unit L2, and is for ensuring a share of magnification variation while correcting the spherical aberration and coma well. If the value is larger than the upper limit of the inequality (11), the refractive power of the third lens unit L3 is too weak and the magnification variation effect weakens, which may increase the moving amount of the third lens unit L3 during zooming. If the value is smaller than the lower limit of the inequality (11), the refractive power of the third lens unit L3 is too strong, which causes spherical aberration and coma on the telephoto side and an astigmatic difference at a screen center area.

The inequality (12) specifies the focal length of the third lens unit L3 relative to the focal length of the zoom lens at the telephoto end and is for correcting field curvature in the telephoto range and reducing the size of the zoom lens. If the value is larger than the upper limit of the inequality (12), the refractive power of the third lens unit L3 is too weak, and the field curvature on the telephoto side is likely to increase. If the value is smaller than the lower limit of the inequality (12), the refractive power of the third lens unit L3 is too strong, and coma varies depending on the image height on the telephoto side.

The inequality (13) specifies the average Abbe number of the positive lens(es) included in the third lens unit L3, and is for reducing the overall lens length and reducing on-axis chromatic aberration and lateral chromatic aberration. If the value is larger than the upper limit of the inequality (13), it is beneficial to reduction of on-axis chromatic aberration and lateral chromatic aberration, but the curvature radius of the lens is close to zero, which may cause insufficient correction on spherical aberration and coma. If the value is smaller than the lower limit of the inequality (13), chromatic aberration increases, making it difficult for the zoom lens as a whole to correct aberration.

The numerical ranges of the inequalities (4) to (13) may be set to numerical ranges of the following inequalities (4a) to (13a).

−0.07<SFA<1.00 (4a)

0.8<|APR2/fGP|<1.7 (5a)

70.6<νdAP<96.0 (6a)

0.65<νdAN/νdAP<0.80 (7a)

−1.70<fA/fB<−0.54 (8a)

4.4<|f1/f2|<6.0 (9a)

4.0<f1/fw<5.0 (10a)

1.1<|f3/f2|<2.4 (11a)

0.18<f3/ft<0.45 (12a)

60<νd3P<77 (13a)

When the inequality (4a) is satisfied, spherical aberration is more properly corrected in the wide-angle range, making it easier to increase the lens diameter. Satisfying the inequality (5a) makes it easy to correct on-axis chromatic aberration and properly set the shares of magnification variation. Satisfying the inequality (6a) makes it easy to correct on-axis chromatic aberration in the telephoto range. Satisfying the inequality (7a) makes it easy to reduce a variation in on-axis chromatic aberration during zooming. Satisfying the inequality (8a) makes it easy to properly set the shares of aberration correction of the two cemented lenses. Satisfying the inequality (9a) makes it easy to shorten the overall lens length. Satisfying the inequality (10a) makes it easy to correct both the lateral chromatic aberration on the wide-angle side and the spherical aberration on the telephoto side. Satisfying the inequality (11a) more properly set the share of magnification variation of the third lens unit L3, making it easy to reduce a variation in coma during zooming. Satisfying the inequality (12a) makes it easy to reduce variations in coma depending on a position in the angle of view in the telephoto range. Satisfying the inequality (13a) makes it easy to shorten the overall lens length.

The numerical ranges of the inequalities (4) to (13) may be set to numerical ranges of the following inequalities (4b) to (13b).

−0.05<SFA<0.70 (4b)

0.90<|APR2/fGP|<1.65 (5b)

70.69<νdAP<83.00 (6b)

0.68<νdAN/νdAP<0.75 (7b)

−1.60<fA/fB<−0.57 (8b)

4.6<|f1/f2|<5.4 (9b)

4.1<f1/fw<4.8 (10b)

1.2<|f3/f2|<2.2 (11b)

0.20<f3/ft<0.40 (12b)

62<νd3P<74 (13b)

Next, a description is given of configurations that may be satisfied in the zoom lens according to each example.

The first lens unit L1 may consist of three or less lenses.

This configuration makes it possible to reduce the number of lenses in the first lens unit L1 having a large lens diameter, and to reduce the size and weight. In addition, a height of a ray emitted from the first lens unit L1 can be lowered, and off-axis aberration such as coma and field curvature can be corrected well.

The first lens unit L1 may consist of, in order from the object side to the image side, a cemented lens including a negative lens and a positive lens, and a meniscus-shaped single lens having a positive refractive power. This configuration makes it easy to correct well lateral chromatic aberration in the entire zoom range and to correct well spherical aberration and on-axis chromatic aberration on the telephoto side.

The second lens unit L2 may consist of four spherical lenses including, in order from the object side to the image side, a lens having a negative refractive power, a lens having a negative refractive power, a lens having a positive refractive power, and a lens having a negative refractive power. When the second lens unit L2 consists of the spherical lenses, it is possible to reduce surface shape errors (errors in astigmatism and distortion components) that are likely to occur in aspherical lenses.

This configuration can increase the refractive power of the second lens unit L2 and correct both lateral chromatic aberration and field curvature in the wide-angle range and spherical aberration in the telephoto range. When the negative lens is disposed at a position closest to the object side in the second lens unit L2, a power arrangement in the second lens unit L2 can be made to be a retro focus type, field curvature and coma in the wide-angle range are corrected well.

The third lens unit L3 may include a single lens that is closest to the object side in the third lens unit L3, has a positive refractive power, and is convex toward the object side. A ray height is high of a light beam emitted from the second lens unit L2, which is a main magnification variation unit, and entering the third lens unit L3, and thus high-order spherical aberration and coma may be caused. Therefore, in order that the occurrence is effectively reduced of spherical aberration and coma, the lens that is closest to the object side in the third lens unit L3, has the positive refractive power, and is convex toward the object side makes the diverging light beam from the second lens unit L2 converge.

A lens closest to the image side in a lens unit closest to the image side may be a positive lens convex toward the image side. This configuration makes it relatively easy to ensure a back focus and can hinder unnecessary light (ghost) from being collected by the image sensor.

The rear unit RG may include at least one aspherical surface. This configuration can reduce the size of the zoom lens while effectively correcting field curvature at the wide-angle end.

A lens on the image side of the aperture diaphragm SP and next to the aperture diaphragm SP may consist of a biconvex-shaped lens element (single lens or cemented lens) having a strong convex shape on the object side. The lens surface having the strong convex shape facing the aperture diaphragm SP makes it easy to reduce spherical aberration caused by an increase in the lens diameter and to correct various off-axis aberrations in the wide-angle range. In a case where the lens element having the strong convex shape has an aspherical surface, it is easy to achieve both correction on spherical aberration and coma and correction on field curvature.

In the zoom lens according to each example, all or part of any lens unit may serve as an image stabilizing unit that performs image stabilization by moving in a direction(s) including a component of a direction orthogonal to the optical axis, or by rotationally moving (oscillating) in an in-plane direction of a plane including the optical axis. In particular, the cemented lens B may serve as an image stabilizing unit. There are no particular limitations on the number of lenses or a shape of the image stabilizing unit. The image stabilizing unit may have a positive refractive power. The image stabilizing unit may consist of part of one lens unit, and may consist of a central part when one lens unit is divided into three parts.

In the zoom lens according to each example, a whole or part of any lens unit may serve as a focus unit that performs focusing by moving in a direction(s) including a component in the optical axis direction.

Next, a detailed description is given of the zoom lens according to each example.

In Example 1 illustrated FIG. 1, a reference sign L1 denotes a positive first lens unit (first lens unit having a positive refractive power), a reference sign L2 denotes a negative second lens unit, a reference sign L3 denotes a positive third lens unit, a reference sign L4 denotes a positive fourth lens unit, a reference sign L5 denotes a negative fifth lens unit, a reference sign L6 denotes a negative sixth lens unit, and a reference sign L7 denotes a positive seventh lens unit. The lens unit GP includes the third lens unit L3 and the fourth lens unit L4. A cemented lens A is a lens element having a negative refractive power in which a ninth lens and a tenth lens, which are counted from an object side, are cemented to each other. A cemented lens B is a lens element having a positive refractive power in which an eleventh lens and a twelfth lens, which are counted from the object side, are cemented to each other.

In the zoom lens according to Example 1, the first lens unit L monotonously moves to the object side during zooming from a wide-angle end to a telephoto end. Each lens unit moves so that, at the telephoto end, a distance between the first lens unit L1 and the second lens unit L2 is wide, a distance between the second lens unit L2 and the third lens unit L3 is narrow, and a distance between the third lens unit L3 and the fourth lens unit L4 is wide, as compared with those at the wide-angle end. During focusing, the fifth lens unit L5 moves.

In each of Examples 2, 3, and 4 illustrated in FIGS. 3, 5, and 7, a reference sign L1 denotes a positive first lens unit, a reference sign L2 denotes a negative second lens unit, a reference sign L3 denotes a positive third lens unit, a reference sign L4 denotes a negative fourth lens unit, a reference sign L5 denotes a negative fifth lens unit, and a reference sign L6 denotes a positive sixth lens unit. A lens unit GP is the third lens unit L3.

In each of Examples 2 and 4, the cemented lens A is a lens element having a negative refractive power in which a ninth lens and a tenth lens are cemented to each other. A cemented lens B is a lens element having a positive refractive power in which an eleventh lens and a twelfth lens are cemented to each other. In Example 3, a cemented lens A is a lens element having a negative refractive power in which a tenth lens and an eleventh lens are cemented to each other, and a cemented lens B is a lens element having a positive refractive power in which a twelfth lens and a thirteenth lens are cemented to each other.

In each of the zoom lenses according to Examples 2, 3, and 4, the first lens unit L1 monotonously moves to an object side during zooming from a wide-angle end to a telephoto end. Each lens unit moves so that, at the telephoto end, a distance between the first lens unit L1 and the second lens unit L2 is wide, and a distance between the second lens unit L2 and the third lens unit L3 is narrow, as compared with those at the wide-angle end. The fourth lens unit L4 moves during focusing.

In Example 5 illustrated in FIG. 9, a reference sign L1 denotes a positive first lens unit, a reference sign L2 denotes a negative second lens unit, a reference sign L3 denotes a positive third lens unit, a reference sign L4 denotes a negative fourth lens unit, and a reference sign L5 denotes a positive fifth lens unit. A lens unit GP is the third lens unit L3. A cemented lens A is a lens element having a negative refractive power in which a ninth lens and a tenth lens are cemented to each other. A cemented lens B is a lens element having a positive refractive power in which an eleventh lens and a twelfth lens are cemented to each other.

In the zoom lens according to Example 5, the first lens unit L monotonously moves to an object side during zooming from a wide-angle end to a telephoto end. Each lens unit moves so that, at the telephoto end, a distance between the first lens unit L1 and the second lens unit L2 is wide, and a distance between the second lens unit L2 and the third lens unit L3 is narrow. The fourth lens unit L4 moves during focusing, as compared with those at the wide-angle end.

In Example 6 illustrated in FIG. 11, a reference sign L1 denotes a positive first lens unit, a reference sign L2 denotes a negative second lens unit, a reference sign L3 denotes a positive third lens unit, a reference sign L4 denotes a positive fourth lens unit, a reference sign L5 denotes a negative fifth lens unit, and a reference sign L6 denotes a positive sixth lens unit. The lens unit GP includes the third lens unit L3 and the fourth lens unit L4. A cemented lens A is a lens element having a negative refractive power in which a ninth lens and a tenth lens are cemented to each other. A cemented lens B is a lens element having a positive refractive power in which an eleventh lens and a twelfth lens are cemented to each other.

In the zoom lens according to Example 6, the first lens unit L1 monotonously moves to an object side during zooming from a wide-angle end to a telephoto end. Each lens unit moves so that, at the telephoto end, a distance between the first lens unit L1 and the second lens unit L2 is wide, a distance between the second lens unit L2 and the third lens unit L3 is narrow, and a distance between the third lens unit L3 and the fourth lens unit L4 is narrow, as compared with those at the wide-angle end. The fifth lens unit L5 moves during focusing.

Numerical Examples 1 to 6 respectively corresponding to Examples 1 to 6 are given below.

In surface data of each numerical example, r represents a curvature radius of each optical surface, and d (mm) represents an on-axis distance (distance on the optical axis) between an m-th surface and an (m+1)-th surface. m is a surface number counted from a light entering side. nd represents a refractive index at the d-line of each optical member, and νd represents an Abbe number of the optical member. An Abbe number νd and a partial dispersion ratio θgF of a certain material are expressed by the following equations where Nd, NF, NC, and Ng represent refractive indexes at the d-line (587.6 nm), the F-line (486.1 nm), the C-line (656.3 nm), and the g-line (435.8 nm) of Fraunhofer lines.

νd=(Nd−1)/(NF−NC)

θgF=(Ng−NF)/(NF−NC)

In each numerical example, values of d, focal length (mm), F-number, and half angle of view (°) are all values in a state where the zoom lens according to each example focuses on an object at an infinite distance. “Back Focus BF” is an air conversion length of a distance on the optical axis from a lens last surface (lens surface closest to the image side) to a paraxial image plane. “Overall Lens Length” is a length acquired by adding the back focus to a distance on the optical axis from a foremost lens surface of the zoom lens (lens surface closest to the object side) to the last surface. “Lens Unit” is not limited to a configuration including a plurality of lenses, but may have a configuration consisting of a single lens.

In a case where an optical surface is an aspherical surface, a sign * is attached to a right side of a surface number. An aspherical shape is expressed by the following equation where X represents a displacement amount from a surface vertex in the optical axis direction, h represents a height from the optical axis in the direction orthogonal to the optical axis, R represents a paraxial curvature radius, k represents a conic constant, and A4, A6, A8, A10 and A12 represent aspherical surface coefficients of respective orders.

x=(h²/R)/[1+{1−(1+k)(h/R)²}^{1/2}]+A4×h⁴+A6×h⁶+A8×h⁸+A10×h¹⁰+A12×h¹²

“e±XX” in each aspherical surface coefficient represents “×10^{±XX}”.

### NUMERICAL EXAMPLE 1

Unit mm
SURFACE DATA

| Surface Number | r | d | nd | νd | θgF |
|---|---|---|---|---|---|
| 1 | 123.206 | 1.50 | 1.92286 | 20.88 | 0.6391 |
| 2 | 66.828 | 5.58 | 1.61800 | 63.40 | 0.5395 |
| 3 | −464.077 | 0.25 | | | |
| 4 | 43.861 | 4.97 | 1.69680 | 55.53 | 0.5434 |
| 5 | 151.415 | (Variable) | | | |
| 6 | 111.979 | 0.90 | 1.95375 | 32.32 | 0.5898 |
| 7 | 12.847 | 5.64 | | | |
| 8 | −27.915 | 0.80 | 1.87070 | 40.73 | 0.5686 |
| 9 | 48.809 | 0.20 | | | |
| 10 | 28.449 | 4.57 | 1.92119 | 23.96 | 0.6203 |
| 11 | −26.495 | 0.59 | | | |
| 12 | −19.303 | 0.80 | 1.72916 | 54.68 | 0.5444 |
| 13 | −68.905 | (Variable) | | | |
| 14(Diaphragm) | ∞ | 0.60 | | | |
| 15* | 15.738 | 4.27 | 1.55332 | 71.69 | 0.5402 |
| 16* | −45.933 | 0.25 | | | |
| 17 | 52.284 | 4.08 | 1.49700 | 81.54 | 0.5375 |
| 18 | −15.890 | 0.80 | 1.51823 | 58.90 | 0.5457 |
| 19 | 13.720 | 2.31 | | | |
| 20 | 27.621 | 0.80 | 1.83400 | 37.21 | 0.5807 |
| 21 | 15.339 | 3.16 | 1.59282 | 68.62 | 0.5458 |
| 22 | −315.513 | (Variable) | | | |
| 23 | 23.005 | 4.57 | 1.61800 | 63.40 | 0.5395 |
| 24 | −13.556 | 0.80 | 1.91650 | 31.60 | 0.5911 |
| 25 | −24.224 | (Variable) | | | |
| 26 | 67.433 | 0.80 | 1.74100 | 52.64 | 0.5467 |
| 27 | 13.200 | (Variable) | | | |
| 28* | −219.833 | 1.80 | 1.58313 | 59.38 | 0.5423 |
| 29* | 193.213 | (Variable) | | | |
| 30 | −79.761 | 3.77 | 1.62041 | 60.29 | 0.5427 |
| 31 | −25.977 | (Variable) | | | |
| Image Plane | ∞ | | | | |

ASPHERICAL DATA

15th Surface
K = 0.00000e+000 A 4 = −2.68014e−005 A 6 = −1.51087e−007
A 8 = 1.84722e−009 A10 = −2.71938e−011
16th Surface
K = 0.00000e+000 A 4 = 2.76611e−005 A 6 = −1.59524e−007
A 8 = 2.00775e−009 A10 = −2.74372e−011
28th Surface
K = 0.00000e+000 A 4 = −2.04383e−004 A 6 = −1.04758e−006
A 8 = 4.38595e−008 A10 = −6.31993e−010 A12 = 3.09385e−012
29th Surface
K = 0.00000e+000 A 4 = −1.81227e−004 A 6 = −3.38180e−007
A 8 = 2.34179e−008 A10 = −3.02899e−010 A12 = 1.25523e−012

VARIOUS DATA
Zoom Ratio 4.40

| | Wide Angle | Middle | Telephoto |
|---|---|---|---|
| Focal Length: | 15.45 | 36.03 | 67.94 |
| F-number: | 4.12 | 4.12 | 4.12 |
| Half Angle of View (°): | 41.27 | 19.59 | 10.60 |
| Image Height: | 12.66 | 13.66 | 13.66 |
| Overall Lens Length: | 100.14 | 108.00 | 120.23 |
| BF: | 10.46 | 10.79 | 12.37 |
| d 5 | 0.70 | 12.96 | 25.75 |
| d13 | 22.92 | 8.59 | 3.29 |
| d22 | 0.80 | 1.27 | 1.35 |
| d25 | 1.56 | 3.50 | 3.36 |
| d27 | 8.85 | 6.45 | 6.51 |
| d29 | 1.05 | 10.66 | 13.82 |
| d31 | 10.46 | 10.79 | 12.37 |

ZOOM LENS UNIT DATA

| Unit | Starting Surface | Focal Length |
|---|---|---|
| 1 | 1 | 64.00 |
| 2 | 6 | −13.48 |
| 3 | 14 | 26.77 |
| 4 | 23 | 24.17 |
| 5 | 26 | −22.29 |
| 6 | 28 | −176.06 |
| 7 | 30 | 60.47 |

### NUMERICAL EXAMPLE 2

Unit mm
SURFACE DATA

| Surface Number | r | d | nd | νd | θgF |
|---|---|---|---|---|---|
| 1 | 101.257 | 1.50 | 1.92286 | 20.88 | 0.6391 |
| 2 | 60.291 | 5.73 | 1.59282 | 68.62 | 0.5458 |
| 3 | −4456.172 | 0.25 | | | |
| 4 | 42.966 | 4.60 | 1.69680 | 55.53 | 0.5434 |
| 5 | 158.953 | (Variable) | | | |
| 6 | 99.609 | 0.90 | 1.95375 | 32.32 | 0.5898 |
| 7 | 13.291 | 5.85 | | | |
| 8 | −32.886 | 0.80 | 1.87070 | 40.73 | 0.5686 |
| 9 | 38.107 | 0.20 | | | |
| 10 | 27.182 | 4.69 | 1.92119 | 23.96 | 0.6203 |
| 11 | −34.023 | 1.04 | | | |
| 12 | −19.649 | 0.80 | 1.55200 | 70.70 | 0.5421 |
| 13 | −92.753 | (Variable) | | | |
| 14(Diaphragm) | ∞ | 0.60 | | | |
| 15* | 16.457 | 4.63 | 1.58313 | 59.38 | 0.5423 |
| 16* | −68.118 | 0.25 | | | |
| 17 | 48.885 | 3.47 | 1.53775 | 74.70 | 0.5392 |
| 18 | −19.399 | 0.80 | 1.51742 | 52.43 | 0.5564 |
| 19 | 15.364 | 2.05 | | | |
| 20 | 29.727 | 0.80 | 1.83481 | 42.74 | 0.5648 |
| 21 | 16.042 | 2.96 | 1.59282 | 68.62 | 0.5458 |
| 22 | −364.901 | 0.84 | | | |
| 23 | 29.252 | 5.18 | 1.72916 | 54.68 | 0.5444 |
| 24 | −11.979 | 0.80 | 1.91650 | 31.60 | 0.5911 |
| 25 | −25.127 | (Variable) | | | |
| 26 | 975.106 | 0.80 | 1.85150 | 40.78 | 0.5695 |
| 27 | 15.191 | (Variable) | | | |
| 28* | 197.091 | 1.90 | 1.53110 | 55.91 | 0.5684 |
| 29* | 60.563 | (Variable) | | | |
| 30 | 4252.772 | 5.11 | 1.59410 | 60.47 | 0.5550 |
| 31 | −26.104 | (Variable) | | | |
| Image Plane | ∞ | | | | |

ASPHERICAL DATA

15th Surface
K = 0.00000e+000 A 4 = −2.53346e−006 A 6 = 1.78537e−007
A 8 = −8.04903e−010 A10 = 6.70995e−011
16th Surface
K = 0.00000e+000 A 4 = 5.48471e−005 A 6 = 2.41490e−007
A 8 = −1.10585e−009 A10 = 9.23529e−011
28th Surface
K = 0.00000e+000 A 4 = −2.17094e−004 A 6 = −1.28876e−006
A 8 = 4.43371e−008 A10 = −6.71659e−010 A12 = 3.68763e−012
29th Surface
K = 0.00000e+000 A 4 = −1.88532e−004 A 6 = −4.86363e−007
A 8 = 2.32061e−008 A10 = −2.91056e−010 A12 = 1.30530e−012

VARIOUS DATA
Zoom Ratio 4.40

| | Wide Angle | Middle | Telephoto |
|---|---|---|---|
| Focal Length: | 15.45 | 36.49 | 68.04 |
| F-number: | 2.88 | 3.86 | 4.12 |
| Half Angle of View (°): | 41.38 | 19.53 | 10.61 |
| Image Height: | 12.66 | 13.66 | 13.66 |
| Overall Lens Length: | 100.32 | 110.44 | 118.71 |
| BF: | 10.62 | 11.68 | 15.59 |
| d 5 | 0.70 | 14.07 | 25.79 |
| d13 | 22.06 | 8.62 | 1.17 |
| d25 | 1.69 | 3.05 | 3.66 |
| d27 | 7.78 | 6.42 | 5.81 |
| d29 | 0.91 | 10.04 | 10.13 |
| d31 | 10.62 | 11.68 | 15.59 |

ZOOM LENS UNIT DATA

| Unit | Starting Surface | Focal Length |
|---|---|---|
| 1 | 1 | 64.00 |
| 2 | 6 | −13.50 |
| 3 | 14 | 16.59 |
| 4 | 26 | −18.13 |
| 5 | 28 | −165.42 |
| 6 | 30 | 43.69 |

### NUMERICAL EXAMPLE 3

Unit mm
SURFACE DATA

| Surface Number | r | d | nd | νd | θgF |
|---|---|---|---|---|---|
| 1 | 97.661 | 1.50 | 1.92286 | 20.88 | 0.6391 |
| 2 | 58.555 | 5.87 | 1.59282 | 68.62 | 0.5458 |
| 3 | −1996.145 | 0.25 | | | |
| 4 | 44.217 | 4.84 | 1.69680 | 55.53 | 0.5434 |
| 5 | 169.020 | (Variable) | | | |
| 6 | 130.464 | 0.90 | 1.95375 | 32.32 | 0.5898 |
| 7 | 13.417 | 5.61 | | | |
| 8 | −33.393 | 0.80 | 1.87070 | 40.73 | 0.5686 |
| 9 | 33.979 | 0.20 | | | |
| 10 | 25.723 | 4.84 | 1.92119 | 23.96 | 0.6203 |
| 11 | −33.108 | 1.05 | | | |
| 12 | −19.402 | 0.80 | 1.55200 | 70.70 | 0.5421 |
| 13 | −71.066 | (Variable) | | | |
| 14(Diaphragm) | ∞ | 0.60 | | | |
| 15 | 15.204 | 0.70 | 1.65160 | 58.55 | 0.5425 |
| 16 | 9.870 | 4.90 | 1.51633 | 64.06 | 0.5333 |
| 17* | −95.198 | 0.25 | | | |
| 18 | 22.963 | 3.84 | 1.55200 | 70.70 | 0.5421 |
| 19 | −24.345 | 0.80 | 1.57099 | 50.80 | 0.5588 |
| 20 | 15.024 | 1.55 | | | |
| 21 | 27.122 | 0.80 | 1.85150 | 40.78 | 0.5695 |
| 22 | 15.005 | 3.00 | 1.59282 | 68.62 | 0.5458 |
| 23 | −233.617 | 0.58 | | | |
| 24 | 28.481 | 4.97 | 1.72916 | 54.68 | 0.5444 |
| 25 | −12.138 | 0.80 | 1.83400 | 37.34 | 0.5790 |
| 26 | −30.268 | (Variable) | | | |
| 27 | 272.727 | 0.80 | 1.85150 | 40.78 | 0.5695 |
| 28 | 14.980 | (Variable) | | | |
| 29* | −304.916 | 1.90 | 1.53110 | 55.91 | 0.5684 |
| 30* | 166.458 | (Variable) | | | |
| 31 | −209.281 | 3.84 | 1.59410 | 60.47 | 0.5550 |
| 32 | −28.556 | (Variable) | | | |
| Image Plane | ∞ | | | | |

ASPHERICAL DATA

17th Surface
K = 0.00000e+000 A 4 = 3.94800e−005 A 6 = −2.50399e−008
A 8 = −1.60986e−010 A10 = −6.81649e−012
29th Surface
K = 0.000006+000 A 4 = −2.34513e−004 A 6 = −7.30053e−007
A 8 = 3.42430e−008 A10 = −6.55075e−010 A12 = 4.36794e−012
30th Surface
K = 0.0000063−000 A 4 = −1.90964e−004 A 6 = −2.32987e−007
A 8 = 1.99577e−008 A10 = −3.06930e−010 A12 = 1.65135e−012

VARIOUS DATA
Zoom Ratio 4.40

| | Wide Angle | Middle | Telephoto |
|---|---|---|---|
| Focal Length: | 15.45 | 36.47 | 68.05 |
| F-number: | 2.88 | 3.81 | 4.12 |
| Half Angle of View (°): | 41.28 | 19.17 | 10.42 |
| Image Height: | 12.66 | 13.66 | 13.66 |
| Overall Lens Length: | 100.14 | 109.96 | 118.75 |
| BF: | 11.46 | 9.98 | 13.02 |
| d 5 | 0.70 | 14.51 | 25.88 |
| d13 | 22.49 | 9.61 | 2.72 |
| d26 | 1.67 | 2.83 | 3.01 |
| d28 | 6.99 | 5.82 | 5.65 |
| d30 | 0.84 | 11.22 | 12.49 |
| d32 | 11.46 | 9.98 | 13.02 |

ZOOM LENS UNIT DATA

| Unit | Starting Surface | Focal Length |
|---|---|---|
| 1 | 1 | 63.50 |
| 2 | 6 | −13.80 |
| 3 | 14 | 16.60 |
| 4 | 27 | −18.64 |
| 5 | 29 | −202.46 |
| 6 | 31 | 55.22 |

### NUMERICAL EXAMPLE 4

Unit mm
SURFACE DATA

| Surface Number | r | d | nd | νd | θgF |
|---|---|---|---|---|---|
| 1 | 87.053 | 1.80 | 1.92119 | 23.96 | 0.6203 |
| 2 | 55.246 | 6.60 | 1.52841 | 76.46 | 0.5396 |
| 3 | 4555.935 | 0.25 | | | |
| 4 | 51.113 | 4.99 | 1.69680 | 55.53 | 0.5434 |
| 5 | 211.575 | (Variable) | | | |
| 6 | 88.373 | 0.90 | 1.95375 | 32.32 | 0.5898 |
| 7 | 13.186 | 5.83 | | | |
| 8 | −37.162 | 0.80 | 1.87070 | 40.73 | 0.5686 |
| 9 | 35.339 | 0.20 | | | |
| 10 | 24.993 | 4.60 | 1.92119 | 23.96 | 0.6203 |
| 11 | −39.335 | 1.20 | | | |
| 12 | −19.465 | 0.80 | 1.49700 | 81.54 | 0.5375 |
| 13 | −141.682 | (Variable) | | | |
| 14(Diaphragm) | ∞ | 0.60 | | | |
| 15* | 16.997 | 4.59 | 1.58313 | 59.38 | 0.5423 |
| 16* | −53.106 | 0.2.5 | | | |
| 17 | 92.533 | 3.52 | 1.55200 | 70.70 | 0.5421 |
| 18 | −16.940 | 0.80 | 1.51742 | 52.43 | 0.5564 |
| 19 | 15.864 | 2.13 | | | |
| 20 | 26.027 | 0.80 | 1.83400 | 37.21 | 0.5807 |
| 21 | 14.231 | 3.39 | 1.59282 | 68.62 | 0.5458 |
| 22 | −180.390 | 0.91 | | | |
| 23 | 39.643 | 4.31 | 1.75500 | 52.32 | 0.5474 |
| 24 | −14.321 | 0.80 | 1.91650 | 31.60 | 0.5911 |
| 25 | −27.389 | (Variable) | | | |
| 26 | 124.907 | 0.80 | 1.85150 | 40.78 | 0.5695 |
| 27 | 16.724 | (Variable) | | | |
| 28* | −310.168 | 1.90 | 1.53110 | 55.91 | 0.5684 |
| 29* | 60.508 | (Variable) | | | |
| 30 | 191.151 | 4.62 | 1.61800 | 63.40 | 0.5395 |
| 31 | −33.418 | (Variable) | | | |
| Image Plane | ∞ | | | | |

ASPHERICAL DATA

15th Surface
K = 0.00000e+000 A 4 = −1.60043e−005 A 6 = 2.57695e−007
A 8 = −4.70731e−009 A10 = 6.82356e−011
16th Surface
K = 0.00000e+000 A 4 = 4.50517e−005 A 6 = 3.46001e−007
A 8 = −6.66873e−009 A10 = 9.29389e−011
28th Surface
K = 0.00000e+000 A 4 = −2.30614e−004 A 6 = 2.60574e−008
A 8 = 2.37314e−008 A10 = −3.80826e−010 A12 = 2.01550e−012
29th Surface
K = 0.00000e+000 A 4 = −2.06759e−004 A 6 = 7.95814e−007
A 8 = 5.13152e−009 A10 = −1.10127e−010 A12 = 5.43574e−013

VARIOUS DATA
Zoom Ratio 5.42

| | Wide Angle | Middle | Telephoto |
|---|---|---|---|
| Focal Length: | 15.45 | 36.29 | 83.77 |
| F-number: | 2.88 | 4.00 | 5.80 |
| Half Angle of View (°): | 41.36 | 19.65 | 8.71 |
| Image Height: | 12.66 | 13.66 | 13.66 |
| Overall Lens Length: | 101.54 | 116.35 | 133.85 |
| BF: | 12.12 | 12.61 | 16.91 |
| d 5 | 0.70 | 15.37 | 34.25 |
| d13 | 20.64 | 8.48 | 0.93 |
| d25 | 1.48 | 2.89 | 2.93 |
| d27 | 8.36 | 6.94 | 6.91 |
| d29 | 0.86 | 12.68 | 14.53 |
| d31 | 12.12 | 12.61 | 16.91 |

ZOOM LENS UNIT DATA

| Unit | Starting Surface | Focal Length |
|---|---|---|
| 1 | 1 | 73.20 |
| 2 | 6 | −13.60 |
| 3 | 14 | 16.95 |
| 4 | 26 | −22.75 |
| 5 | 28 | −95.16 |
| 6 | 30 | 46.39 |

### NUMERICAL EXAMPLE 5

Unit mm
SURFACE DATA

| Surface Number | r | d | nd | νd | θgF |
|---|---|---|---|---|---|
| 1 | 86.086 | 1.80 | 1.92119 | 23.96 | 0.6203 |
| 2 | 52.542 | 6.59 | 1.52841 | 76.46 | 0.5396 |
| 3 | 1004.135 | 0.25 | | | |
| 4 | 47.766 | 5.32 | 1.69680 | 55.53 | 0.5434 |
| 5 | 205.752 | (Variable) | | | |
| 6 | 63.302 | 0.90 | 1.95375 | 32.32 | 0.5898 |
| 7 | 12.905 | 6.22 | | | |
| 8 | −36.053 | 0.80 | 1.87070 | 40.73 | 0.5686 |
| 9 | 38.451 | 0.20 | | | |
| 10 | 28.453 | 4.43 | 1.92119 | 23.96 | 0.6203 |
| 11 | −35.825 | 1.22 | | | |
| 12 | −18.744 | 0.80 | 1.49700 | 81.54 | 0.5375 |
| 13 | −180.756 | (Variable) | | | |
| 14(Diaphragm) | ∞ | 0.60 | | | |
| 15* | 18.234 | 4.11 | 1.58313 | 59.38 | 0.5423 |
| 16* | −71.410 | 0.25 | | | |
| 17 | 26.853 | 4.09 | 1.52841 | 76.46 | 0.5396 |
| 18 | −26.171 | 0.80 | 1.51742 | 52.43 | 0.5564 |
| 19 | 14.660 | 2.37 | | | |
| 20 | 23.248 | 0.80 | 1.83400 | 37.21 | 0.5807 |
| 21 | 13.128 | 3.58 | 1.59282 | 68.62 | 0.5458 |
| 22 | 4631.643 | 0.98 | | | |
| 23 | 177.568 | 3.93 | 1.75500 | 52.32 | 0.5474 |
| 24 | −13.676 | 0.80 | 1.91650 | 31.60 | 0.5911 |
| 25 | −27.550 | (Variable) | | | |
| 26 | −37.269 | 0.80 | 1.85150 | 40.78 | 0.5695 |
| 27 | 43.931 | (Variable) | | | |
| 28* | −283.811 | 1.90 | 1.69350 | 53.18 | 0.5482 |
| 29* | 103.220 | 0.30 | | | |
| 30 | 42.041 | 5.62 | 1.51633 | 64.14 | 0.5353 |
| 31 | −37.748 | (Variable) | | | |
| Image Plane | ∞ | | | | |

ASPHERICAL DATA

15th Surface
K = 0.00000e+000 A 4 = −1.41740e−005 A 6 = 3.99398e−011
A 8 = −4.41008e−011 A10 = 7.66400e−012
16th Surface
K = 0.00000e+000 A 4 = 1.83828e−005 A 6 = 5.05825e−008
A 8 = −3.04607e−010 A10 = 8.35527e−012
28th Surface
K = 0.00000e+000 A 4 = −2.29240e−004 A 6 = 3.80091e−007
A 8 = 1.87469e−008 A10 = −2.85983e−010 A12 = 1.26659e−012
29th Surface
K = 0.00000e+000 A 4 = −1.99561e−004 A 6 = 9.53036e−007
A 8 = 3.72688e−009 A10 = −8.61757e−011 A12 = 3.56878e−013

VARIOUS DATA
Zoom Ratio 5.09

| | Wide Angle | Middle | Telephoto |
|---|---|---|---|
| Focal Length: | 16.45 | 36.35 | 83.81 |
| F-number: | 2.88 | 4.00 | 5.80 |
| Half Angle of View (°): | 39.72 | 20.12 | 8.62 |
| Image Height: | 12.66 | 13.66 | 13.66 |
| Overall Lens Length: | 104.42 | 114.62 | 126.76 |
| BF: | 11.42 | 21.32 | 15.06 |
| d 5 | 0.70 | 14.73 | 33.41 |
| d13 | 22.19 | 8.47 | 0.86 |
| d25 | 3.37 | 5.16 | 7.88 |
| d27 | 7.29 | 5.49 | 10.10 |
| d31 | 11.42 | 21.32 | 15.06 |

ZOOM LENS UNIT DATA

| Unit | Starting Surface | Focal Length |
|---|---|---|
| 1 | 1 | 72.00 |
| 2 | 6 | −13.42 |
| 3 | 14 | 18.72 |
| 4 | 26 | −23.57 |
| 5 | 28 | 59.66 |

### NUMERICAL EXAMPLE 6

Unit mm
SURFACE DATA

| Surface Number | r | d | nd | νd | θgF |
|---|---|---|---|---|---|
| 1 | 85.769 | 1.80 | 1.92119 | 23.96 | 0.6203 |
| 2 | 52.890 | 6.70 | 1.52841 | 76.46 | 0.5396 |
| 3 | 4501.929 | 0.25 | | | |
| 4 | 49.755 | 5.07 | 1.69680 | 55.53 | 0.5434 |
| 5 | 219.491 | (Variable) | | | |
| 6 | 68.665 | 0.90 | 1.95375 | 32.32 | 0.5898 |
| 7 | 13.105 | 6.06 | | | |
| 8 | −34.525 | 0.80 | 1.87070 | 40.73 | 0.5686 |
| 9 | 35.789 | 0.20 | | | |
| 10 | 27.935 | 4.52 | 1.92119 | 23.96 | 0.6203 |
| 11 | −35.000 | 1.26 | | | |
| 12 | −18.276 | 0.80 | 1.49700 | 81.54 | 0.5375 |
| 13 | −108.531 | (Variable) | | | |
| 14(Diaphragm) | ∞ | 0.60 | | | |
| 15* | 18.233 | 4.11 | 1.58313 | 59.38 | 0.5423 |
| 16* | −74.739 | 0.25 | | | |
| 17 | 28.571 | 3.68 | 1.55032 | 75.50 | 0.5405 |
| 18 | −31.238 | 0.80 | 1.51742 | 52.43 | 0.5564 |
| 19 | 14.821 | 2.01 | | | |
| 20 | 23.757 | 0.80 | 1.83400 | 37.21 | 0.5807 |
| 21 | 13.197 | 3.58 | 1.59282 | 68.62 | 0.5458 |
| 22 | −294.751 | (Variable) | | | |
| 23 | −12460.363 | 3.68 | 1.75500 | 52.32 | 0.5474 |
| 24 | −13.773 | 0.80 | 1.91650 | 31.60 | 0.5911 |
| 25 | −27.092 | (Variable) | | | |
| 26 | −44.781 | 0.80 | 1.85150 | 40.78 | 0.5695 |
| 27 | 42.378 | (Variable) | | | |
| 28* | −226.791 | 1.60 | 1.69350 | 53.18 | 0.5482 |
| 29* | 108.870 | 0.30 | | | |
| 30 | 41.390 | 5.47 | 1.51633 | 64.14 | 0.5353 |
| 31 | −39.101 | (Variable) | | | |
| Image Plane | ∞ | | | | |

ASPHERICAL DATA

15th Surface
K = 0.00000e+000 A 4 = −1.46301e−005 A 6 = −8.71553e−009
A 8 = 1.00002e−010 A10 = 3.85899e−012
16th Surface
K = 0.00000e+000 A 4 = 1.92197e−005 A 6 = 4.43348e−008
A 8 = −3.28205e−010 A10 = 5.72268e−012
28th Surface
K = 0.00000e+000 A 4 = −2.54596e−004 A 6 = 4.00949e−007
A 8 = 2.01627e−008 A10 = −2.77109e−010 A12 = 1.16550e−012
29th Surface
K = 0.00000e+000 A 4 = −2 28119e−004 A 6 = 1.12921e−006
A 8 = 3.59935e−009 A10 = −8.29769e−011 A12 = 3.36865e−013

VARIOUS DATA
Zoom Ratio 5.09

| | Wide Angle | Middle | Telephoto |
|---|---|---|---|
| Focal Length: | 16.48 | 36.15 | 83.82 |
| F-number: | 2.88 | 4.00 | 5.80 |
| Half Angle of View (°): | 39.58 | 20.07 | 8.56 |
| Image Height: | 12.66 | 13.66 | 13.66 |
| Overall Lens Length: | 104.85 | 114.65 | 126.77 |
| BF: | 11.80 | 21.57 | 15.84 |
| d 5 | 0.70 | 14.45 | 33.20 |
| d13 | 22.40 | 8.58 | 0.89 |
| d22 | 1.63 | 1.91 | 0.78 |
| d25 | 3.37 | 5.38 | 8.39 |
| d27 | 8.08 | 5.92 | 10.81 |
| d31 | 11.80 | 21.57 | 15.84 |

ZOOM LENS UNIT DATA

| Unit | Starting Surface | Focal Length |
|---|---|---|
| 1 | 1 | 71.50 |
| 2 | 6 | −13.42 |
| 3 | 14 | 22.47 |
| 4 | 23 | 45.02 |
| 5 | 26 | −25.46 |
| 6 | 28 | 61.60 |

Various values in each numerical example are summarized in Table 1 below.

TABLE 1

| | Ex. 1 | Ex. 2 | Ex. 3 | Ex. 4 | Ex. 5 | Ex. 6 |
|---|---|---|---|---|---|---|
| fw | 15.450 | 15.450 | 15.450 | 15.450 | 16.450 | 16.480 |
| ft | 67.938 | 68.041 | 68.048 | 83.773 | 83.808 | 83.820 |
| f1 | 64.000 | 64.000 | 63.500 | 73.200 | 72.000 | 71.500 |
| f2 | −13.480 | −13.500 | −13.800 | −13.600 | −13.420 | −13.420 |
| f3 | 26.77 | 16.59 | 16.60 | 16.95 | 18.72 | 22.47 |
| f4 | 24.17 | −18.13 | −18.64 | −22.75 | −23.57 | 45.02 |
| f5 | −22.29 | −165.42 | −202.46 | −95.16 | 59.66 | −25.46 |
| f6 | −176.06 | 43.69 | 55.22 | 46.39 | | 61.60 |
| f7 | 60.47 | | | | | |
| f8 | | | | | | |
| f9 | | | | | | |
| fGP | 17.63 | 16.59 | 16.60 | 16.95 | 18.72 | 19.02 |
| fA | −35.181 | −48.532 | −83.415 | −41.567 | −76.997 | −78.902 |
| fB | 60.686 | 67.807 | 59.440 | 54.153 | 56.592 | 52.593 |
| fAP | 25.017 | 26.293 | 22.044 | 26.240 | 25.769 | 27.722 |
| fAN | −14.078 | −16.441 | −16.151 | −15.702 | −18.040 | −19.313 |
| ndAP | 1.49700 | 1.53775 | 1.55200 | 1.55200 | 1.52841 | 1.55032 |
| ν dAP | 81.54 | 74.70 | 70.70 | 70.70 | 76.48 | 75.50 |
| ndAN | 1.51823 | 1.51742 | 1.57099 | 1.51742 | 1.51742 | 1.51742 |
| ν dAN | 58.90 | 52.43 | 50.80 | 52.43 | 52.43 | 52.43 |
| APR1 | 52.284 | 48.885 | 22.963 | 92.533 | 26.853 | 28.571 |
| APR2 | −15.890 | −19.399 | −24.345 | −16.940 | −26.171 | −31.238 |
| ANR2 | 13.7204 | 15.364 | 15.024 | 15.864 | 14.660 | 14.821 |
| skm | 10.459 | 10.623 | 11.461 | 12.120 | 11.419 | 11.805 |
| (1)fAN/fGP | −0.803 | −0.991 | −0.973 | −0.927 | −0.964 | −1.015 |
| (2)\|APR2/APR1\| | 0.304 | 0.397 | 1.060 | 0.183 | 0.975 | 1.093 |
| (3)ndAN | 1.51823 | 1.51742 | 1.57099 | 1.51742 | 1.51742 | 1.51742 |
| (4)SFA | 0.534 | 0.432 | −0.029 | 0.691 | 0.013 | −0.045 |
| (5)\| APR2/fGP \| | 0.907 | 1.170 | 1.467 | 1.000 | 1.398 | 1.642 |
| (6) ν dAP | 81.540 | 74.700 | 70.700 | 70.700 | 76.480 | 75.500 |
| (7) ν dAN/ν dAP | 0.72 | 0.70 | 0.72 | 0.74 | 0.69 | 0.69 |
| (8)fA/fB | −0.58 | −0.72 | −1.40 | −0.77 | −1.36 | −1.50 |
| (9) \| f1/f2 \| | 4.748 | 4.741 | 4.601 | 5.382 | 5.365 | 5.328 |
| (10)f1/fw | 4.142 | 4.142 | 4.110 | 4.738 | 4.377 | 4.339 |
| (11) \| f3/f2 \| | 1.986 | 1.229 | 1.203 | 1.246 | 1.395 | 1.675 |
| (12)f3/ft | 0.394 | 0.244 | 0.244 | 0.202 | 0.223 | 0.268 |
| (13) ν d3P | 73.950 | 64.345 | 64.515 | 62.755 | 64.195 | 67.833 |

### Image Pickup Apparatus

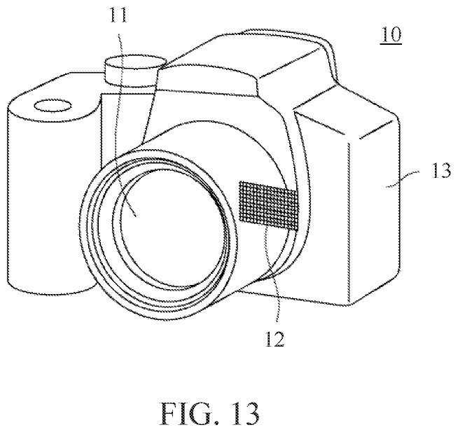

Next, with reference to FIG. 13, a description is given of an embodiment of a digital still camera (image pickup apparatus) 10 that uses the zoom lens according to the present disclosure as an image pickup optical system. In FIG. 13, a reference numeral 13 denotes a camera main body, and a reference numeral 11 denotes an image pickup optical system including the zoom lens according to any of Examples 1 to 6. A reference numeral 12 denotes a solid image sensor (photoelectric conversion element), such as a CCD sensor and a CMOS sensor, that is built in the camera body 13 and receives and photoelectrically converts an optical image formed by the image pickup optical system 11. The camera body 13 may be a so-called single-lens reflex camera having a quick turn mirror, or a so-called mirrorless camera not having a quick turn mirror.

By applying the zoom lens according to the present disclosure to an image pickup apparatus such as a digital still camera in this way, an image pickup apparatus having a small lens can be provided.

According to the above-described embodiments, it is possible to realize a zoom lens that has a wide angle of view and a small size, has high optical performance, and is robust against manufacturing errors.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-167603, filed on Oct. 12, 2021, which is hereby incorporated by reference herein in its entirety.

What is claimed is:

1. A zoom lens consisting of, in order from an object side to an image side:
a first lens unit having a positive refractive power;
a second lens unit having a negative refractive power;
a third lens unit having a positive refractive power; and
a rear unit including one or more lens units,
wherein each distance between adjacent lens units changes during zooming,
wherein during zooming from a wide-angle end to a telephoto end, the first lens unit moves, a distance between the first lens unit and the second lens unit widens, and a distance between the second lens unit and the third lens unit narrows,
wherein in a case where a lens unit on the image side of the third lens unit and immediately next to the third lens unit is not a lens unit having a positive refractive power, a positive unit is the third lens unit, and in a case where the lens unit on the image side of the third lens unit and immediately next to the third lens unit is a lens unit having a positive refractive power, the positive unit is a lens unit consisting of the third lens unit and the lens unit having a positive refractive power,
wherein the positive unit includes, in order from the object side to the image side, a first cemented lens having a negative refractive power and a second cemented lens having a positive refractive power,
wherein the first cemented lens consists of, in order from the object side to the image side, a first lens having a biconvex shape and having a positive refractive power and a second lens having a negative refractive power, and
wherein following inequalities are satisfied:
−1.200<fAN/fGP<−0.795
0.001<|APR2/APR1|<1.150
where fGP represents a focal length of the positive unit at the wide-angle end, fAN represents a focal length of the second lens as a single lens, APR1 represents a curvature radius of an object side of the first lens, and APR2 represents a curvature radius of an image side of the first lens.

2. A zoom lens consisting of, in order from an object side to an image side:
a first lens unit having a positive refractive power;
a second lens unit having a negative refractive power;
a third lens unit having a positive refractive power; and
a rear unit including one or more lens units,
wherein each distance between adjacent lens units changes during zooming,
wherein during zooming from a wide-angle end to a telephoto end, the first lens unit moves, a distance between the first lens unit and the second lens unit widens, and a distance between the second lens unit and the third lens unit narrows,
wherein in a case where a lens unit on the image side of the third lens unit and immediately next to the third lens unit is not a lens unit having a positive refractive power, a positive unit is the third lens unit, and in a case where the lens unit on the image side of the third lens unit and immediately next to the third lens unit is a lens unit having a positive refractive power, the positive unit is a lens unit consisting of the third lens unit and the lens unit having a positive refractive power,
wherein the positive unit includes, in order from the object side to the image side, a first cemented lens having a negative refractive power and a second cemented lens having a positive refractive power,
wherein the first cemented lens consists of, in order from the object side to the image side, a first lens having a biconvex shape and having a positive refractive power and a second lens having a negative refractive power, and
wherein following inequalities are satisfied:
−1.200<fAN/fGP<−0.795
1.45<ndAN<1.64
where fGP represents a focal length of the positive unit at the wide-angle end, fAN represents a focal length of the second lens, and ndAN represents a refractive index at a d-line of the second lens.

3. The zoom lens according to claim 1, wherein a following inequality is satisfied:
−0.10<SFA<1.20
where SFA represents a shape factor of the first cemented lens.

4. The zoom lens according to claim 1, wherein a following inequality is satisfied:
0.7<|APR2/fGP|<1.8
where APR2 represents the curvature radius of the image side of the first lens in the first cemented lens.

5. The zoom lens according to claim 1, wherein a following inequality is satisfied;
70.5<νdAP<100.0
where νdAP represents an Abbe number of the first lens in the first cemented lens.

6. The zoom lens according to claim 1, wherein a following inequality is satisfied:
0.60<νdAN/νdAP<0.85
where νdAP represents an Abbe number of the first lens in the first cemented lens, and νdAN represents an Abbe number of the second lens in the first cemented lens

7. The zoom lens according to claim 1, wherein a following inequality is satisfied:
−2.00<fA/fB<−0.50
where fA represents a focal length of the first cemented lens, and fB represents a focal length of the second cemented lens.

8. The zoom lens according to claim 1, wherein a following inequality is satisfied:
4.2<|f1/f2|<7.0
where f1 represents a focal length of the first lens unit, and f2 represents a focal length of the second lens unit.

9. The zoom lens according to claim 1, wherein a following inequality is satisfied:
3.8<f1/fw<5.5
where f1 represents a focal length of the first lens unit, and fw represents a focal length of the zoom lens at the wide-angle end.

10. The zoom lens according to claim 1, wherein a following inequality is satisfied:
1.0<|f3/f2|<2.8
where f2 represents a focal length of the second lens unit, f3 represents a focal length of the third lens unit.

11. The zoom lens according to claim 1, wherein a following inequality is satisfied:
0.16<f3/ft<0.50
where f3 represents a focal length of the third lens unit, and ft represents a focal length of the zoom lens at the telephoto end.

12. The zoom lens according to claim 1, wherein a following inequality is satisfied:
56<νd3P<80
where νd3P represents an average Abbe number of a positive lens in the third lens unit.

13. The zoom lens according to claim 1, wherein the first lens unit consists of three or less lenses.

14. The zoom lens according to claim 1, wherein the first lens unit consists of, in order from the object side to the image side:
a cemented lens including a negative lens and a positive lens; and
a single lens having a positive refractive power and having a meniscus shape.

15. The zoom lens according to claim 1, wherein the second lens unit consists of four spherical lenses, and consists of, in order from the object side to the image side, a negative lens, a negative lens, a positive lens, and a negative lens.

16. The zoom lens according to claim 1, wherein the third lens unit includes a single lens that is closest to the object side in the third lens unit, has a positive refractive power, and has a shape convex toward the object side.

17. The zoom lens according to claim 1, wherein a lens closest to the image side in a lens unit closest to the image side in the zoom lens is a positive lens having a shape convex toward the image side.

18. The zoom lens according to claim 1, wherein the rear unit includes, in order from the object side to the image side, a fourth lens unit having a positive refractive power and a fifth lens unit.

19. The zoom lens according to claim 1, wherein the rear unit includes, in order from the object side to the image side, a fourth lens unit having a negative refractive power and a fifth lens unit.

20. An image pickup apparatus comprising:
a zoom lens; and
an image sensor configured to receive light of an image formed by the zoom lens,
wherein the zoom lens consists of, in order from an object side to an image side:
a first lens unit having a positive refractive power;
a second lens unit having a negative refractive power;
a third lens unit having a positive refractive power; and
a rear unit including one or more lens units,
wherein each distance between adjacent lens units changes during zooming,
wherein during zooming from a wide-angle end to a telephoto end, the first lens unit moves, a distance between the first lens unit and the second lens unit widens, and a distance between the second lens unit and the third lens unit narrows,
wherein in a case where a lens unit on the image side of the third lens unit and immediately next to the third lens unit is not a lens unit having a positive refractive power, a positive unit is the third lens unit, and in a case where the lens unit on the image side of the third lens unit and immediately next to the third lens unit is a lens unit having a positive refractive power, the positive unit is a lens unit consisting of the third lens unit and the lens unit having a positive refractive power,
wherein the positive unit includes, in order from the object side to the image side, a first cemented lens having a negative refractive power and a second cemented lens having a positive refractive power,
wherein the first cemented lens consists of, in order from the object side to the image side, a first lens having a biconvex shape and having a positive refractive power and a second lens having a negative refractive power, and
wherein following inequalities are satisfied:
−1.200<fAN/fGP<−0.795
0.001<|APR2/APR1|<1.150
where fGP represents a focal length of the positive unit at the wide-angle end, fAN represents a focal length of the second lens as a single lens, APR1 represents a curvature radius of an object side of the first lens, and APR2 represents a curvature radius of an image side of the first lens.
